(19) United States
(12) Patent Application Publication
(10) Pub. No.: US 2024/0385301 A1
(43) Pub. Date: Nov. 21, 2024

(54) DISTANCE MEASURING DEVICE AND METHOD, AND PROGRAM

(71) Applicant: SONY SEMICONDUCTOR SOLUTIONS CORPORATION, KANAGAWA (JP)

(72) Inventors: MITSUHARU OHKI, KANAGAWA (JP); MASAYUKI NAGAO, KANAGAWA (JP)

(21) Appl. No.: 18/569,716

(22) PCT Filed: Feb. 16, 2022
(86) PCT No.: PCT/JP2022/006056

§ 371 Date: Dec. 13, 2023

(30) Foreign Application Priority Data
Jun. 23, 2021 (JP) 2021-104056

(51) Int. Cl. G01S 7/497; G01S 7/48; G01S 17/894; G01S 17/931

(52) U.S. Cl. CPC G01S 7/497; G01S 7/4808; G01S 17/894; G01S 17/931

(57) ABSTRACT

The present technology relates to a distance measuring device and method, and a program that enable appropriate calibration to be performed. The distance measuring device is configured to illuminate with light selectively one or more regions as targets for distance measurement among a plurality of regions, and includes a computation unit that in a case where two or more of the plurality of regions are illuminated with illumination light for the respective regions, calculates a distance to the region based on output data output from each pixel of a sensor that receives light from the plurality of regions, the output data corresponding to an amount of light received at the pixel, based on information regarding a contribution rate of the illumination light for the region in light received at the pixel, and based on a calibration parameter for a case where only the illumination light for one of the regions illuminates, the calibration parameter being calculated for the illumination light for each region as a target for distance measurement. The present technology can be applied to a ToF distance measuring device.

### TECHNICAL FIELD

The present technology relates to a distance measuring device and method, and a program, and particularly relates to a distance measuring device and method, and a program related to setting calibration parameters for possible light emission for each region.

### BACKGROUND ART

A known distance measuring method is the Time-of-Flight (hereinafter referred to as ToF) principle. With the ToF, distance measurement is performed by emitting sine wave light and receiving the light that hits a target and is reflected by the target.

A sensor for receiving the light includes pixels arranged in a two-dimensional array. In other words, the sensor is more specifically an image sensor. Each pixel includes a light receiving element to be able to capture light. Each pixel receives the light in synchronization with the phase of the emitted light and can thus obtain the phase and amplitude of the received sine wave. The phase is based on the emitted sine wave.

The phase at each pixel corresponds to the time it takes for the light from the light emitting unit to enter the sensor after being reflected by the target object. Thus, by multiplying by the speed of light (referred to as c) a value obtained by dividing the phase by 2πf, and further dividing the resulting value by 2, a distance in the direction of capturing an image with that pixel can be calculated. Here, f is the frequency of the emitted sine wave.

NPL 1 describes the operation of the ToF in detail.

Here, in reality, it is not possible to emit light with a pure sine wave. Accordingly, it is necessary to correct the sine wave. Further, a control signal transmitted through the sensor takes time to reach each pixel position within the sensor. Therefore, correction for each pixel position within the sensor is also required. They are called a circular error and a signal propagation delay, respectively. Details regarding these corrections are specified in Chapter 4 of NPL 2.

Since amounts of these corrections differ for each module, calibration is required for each module.

Specifically calibration parameters are determined using existing measurement equipment at the time of shipment. The calibration parameters are then stored in a read only memory (ROM) within a ToF distance measuring device and shipped. When a user performs distance measurement using this ToF distance measuring device, appropriate corrections are made using the calibration parameters stored in the ROM, and correct distance measurement results are output.

Specifically, the calibration parameters to be stored are p₀, . . . , pₘ, b₀, b₁, b₂ as described in Chapter 4 of NPL 2, which is data of about 10 scalar quantities in total.

There is known a ToF distance measuring device that can select a light emitting region (for example, see PTL 1 and PTL 2). Such a ToF distance measuring device will be described in detail below.

FIG. 1 illustrates how distance measurement is selectively performed for one or more of 16 regions in total that are four regions in the vertical direction by four regions in the horizontal direction.

In FIG. 1, for easy understanding, a diagram related to light emission is illustrated in a part indicated by an arrow Q11, and a diagram related to light reception is illustrated in a part indicated by an arrow Q12. In other words, light emission and light reception are illustrated separately.

In FIG. 1, a light emitting region (field of illumination (FOI)) from a light emitting unit, that is, a region that is illuminated with the light output from the light emitting unit, and a light receiving region (field of view (FOV)) at a sensor, that is, a region that is to be captured by the sensor are the same.

As indicated by the arrow Q11, the FOI is divided into 16 regions R101-1 to R101-16. For simplicity of the diagram, the symbols for regions R101-3 to R101-15 are omitted. In addition, in a case where it is not particularly necessary to distinguish the regions R101-1 to R101-16, each region will simply be referred to as a region R101.

The ToF distance measuring device can cause each of the 16 regions R101 to emit light independently. In other words, it can individually illuminate each region R101 with light for distance measurement.

As indicated by the arrow Q12, the FOV region is the same as the FOI region. The sensor can receive light and perform distance measurement for the region R101 to which light is emitted from the light emitting unit among the 16 regions R101-1 to R101-16 divided in the FOI.

In this way, the ToF distance measuring device can emit and receive light to and from only the region to be measured for distance, and can provide efficient distance measurement.

### Citation List

### Patent Literature

[PTL 1]
JP 2020-76619 A
[PTL 2]
WO 2014/097539

### Non Patent Literature

[NPL 1]
Introduction to the Time-of-Flight (ToF) System Design User's Guide, Literature Number: SBAU219D, Texas Instruments Incorporated
[NPL 2]
Fuchs, S., May, S.: Calibration and registration for precise surface reconstruction with time-of-flight cameras. Int. J. Intell. Syst. Technol. Appl. 5, 274-284 (2008)

### SUMMARY

### Technical Problem

The above-described ToF distance measuring device will be simplified and further described. Specifically, an example in which the FOV and FOI are each divided into two instead of 16 will be described.

Now, the FOI is divided into two regions, a region R201-1 and a region R201-2, as indicated by an arrow Q21 in FIG. 2. In a case where it is not particularly necessary to distinguish the regions R201-1 and R201-2, each region will simply be referred to as a region R201.

These two regions R201 can emit light independently, as in the example illustrated in FIG. 1.

As indicated by an arrow Q22 in FIG. 2, the FOV region is the same as the FOI region. For example, as illustrated in FIG. 3, the sensor can receive light and perform distance measurement for the region R201 to which light is emitted from the light emitting unit, that is, R201 that is illuminated with light for distance measurement, among the two regions R201-1 to R201-2 divided in the FOI.

In FIG. 3, a part indicated by an arrow Q31 illustrates a case where only the region R201-1 emits light, and a polygonal line L11 indicates a distribution of light emission intensity in the horizontal direction within the FOI.

A part indicated by an arrow Q32 illustrates a case where only the region R201-2 emits light, and a polygonal line L12 indicates a distribution of light emission intensity in the horizontal direction within the FOI.

A part indicated by an arrow Q33 illustrates a case where both the region R201-1 and the region R201-2 emit light, and a polygonal line L13 indicates a distribution of light emission intensity in the horizontal direction within the FOI.

However, FIG. 3 illustrates ideal cases, and when light is actually emitted, they will be as illustrated in FIG. 4.

Specifically, in the case where only the region R201-1 emits light, it is not actually as indicated by the arrow Q31 in FIG. 3, but as indicated by an arrow Q41 in FIG. 4.

In the example indicated by the arrow Q41 in FIG. 4, the distribution of light emission intensity within the FOI is as indicated by a polygonal line L21. Specifically, the region that is illuminated with light and the region that is not illuminated are not completely separated in the FOI, and the light emission intensity gradually decreases from the illuminated region to the non-illuminated region.

Accordingly, from this example, it can be seen that not only the region R201-1 but also a region near the region R201-1 in the region R201-2 is illuminated with light.

Similarly, in the case where only the region R201-2 emits light, it is not actually as indicated by the arrow Q32 in FIG. 3, but as indicated in an arrow Q42 in FIG. 4, and the distribution of light emission intensity within the FOI is as indicated by a polygonal line L22. Specifically, the region that is illuminated with light and the region that is not illuminated are not completely separated in the FOI, and the light emission intensity gradually decreases from the illuminated region to the non-illuminated region.

What has been described with reference to FIG. 4 will be described again using FIG. 5.

FIG. 5 illustrates the light emission intensity in each case illustrated in FIG. 3. In particular, in FIG. 5, the horizontal axis indicates positions in the horizontal direction within the FOI (region R201), and the vertical axis indicates the light emission intensity at each position.

A polygonal line L31 in a part indicated by an arrow Q51 in FIG. 5 indicates an actual distribution of light emission intensity in the case where only the region R201-1 emits light.

In this case, it is ideal that the distribution of light emission intensity is a step function at the boundary between the region R201-1 and the region R201-2.

However, in reality, as indicated by the polygonal line L31, the intensity around the boundary between the region R201-1 and the region R201-2 gradually decreases.

Similarly, a polygonal line L32 in a part indicated by an arrow Q52 indicates an actual distribution of light emission intensity in the case where only the region R201-2 emits light. In this case as well, the intensity gradually decreases around the boundary between the region R201-1 and the region R201-2.

A part indicated by an arrow Q53 illustrates an actual distribution of light emission intensity in the case where both the region R201-1 and the region R201-2 emit light.

In this case, the light to illuminate is the total of the light that illuminates the region R201-1 and the light that illuminates the region R201-2. Accordingly, the distribution of light emission intensity in this case is obtained by combining the distribution of light emission intensity represented by the polygonal line L31 indicated by the arrow Q51 and the distribution of light emission intensity represented by the polygonal line L32 indicated by the arrow Q52.

As mentioned earlier, since the light for illuminating the region R201-1 is not a pure sine wave, it needs to be corrected. Similarly, since the light for illuminating the region R201-2 is not a pure sine wave, it needs to be corrected.

Since the light for illuminating the region R201-1 and the light for illuminating the region R201-2 are not the same, their respective amounts of correction are different. Specifically, the calibration parameters for the light for illuminating the region R201-1 and the calibration parameters for the light for illuminating the region R201-2 are different.

Accordingly, for distance measurement in the case where only the region R201-1 emits light, correction is performed using the calibration parameters for light for illuminating the region R201-1. For distance measurement in the case where only the region R201-2 emits light, correction is performed using the calibration parameters for light for illuminating the region R201-2.

What kind of correction should be performed in the case where both the region R201-1 and the region R201-2 emit light?

For a region A including the boundary between the region R201-1 and the region R201-2 in the part indicated by the arrow Q53 in FIG. 5, a combined wave of the light for illuminating the region R201-1 and the light for illuminating the region R201-2 is received for distance measurement to be performed.

Since the light for illuminating the region R201-1 and the light for illuminating the region R201-2 are different, the combined wave of the two light rays is different from the light for illuminating the region R201-1 and also from the light for illuminating the region R201-2. In addition, the ratio of “the light for illuminating the region R201-1” and “the light for illuminating the region R201-2” that make up the combined wave depends on the positions of pixels on the sensor where the combined wave is received.

Therefore, it is not known in what format the calibration parameters for the case where both the region R201-1 and the region R201-2 emit light should have, and how the calibration parameters are to be corrected.

In other words, while the above-mentioned PTL 1 and PTL 2 disclose ToF distance measuring devices that can select a light emitting region, there has been no method for implementing calibration although required in practical operations. Thus, there has been no possible distance measurement selective for a plurality of light emitting regions in practical operations.

The present technology has been made in view of such circumstances to enable appropriate calibration to be performed in a ToF distance measuring device that can select a light emitting region.

### Solution to Problem

A distance measuring device according to a first aspect of the present technology is configured to illuminate with light selectively one or more regions as targets for distance measurement among a plurality of regions, and includes a computation unit that in a case where two or more of the plurality of regions are illuminated with illumination light for the respective regions, calculates a distance to the region based on output data output from each pixel of a sensor that receives light from the plurality of regions, the output data corresponding to an amount of light received at the pixel, based on information regarding a contribution rate of the illumination light for the region in light received at the pixel, and based on a calibration parameter for a case where only the illumination light for one of the regions illuminates, the calibration parameter being calculated for the illumination light for each region as a target for distance measurement.

A distance measuring method or a program according to the first aspect of the present technology is for a distance measuring device configured to illuminate with light selectively one or more regions as targets for distance measurement among a plurality of regions, and includes a step of, in a case where two or more of the plurality of regions are illuminated with illumination light for the respective regions, calculating a distance to the region based on output data output from each pixel of a sensor that receives light from the plurality of regions, the output data corresponding to an amount of light received at the pixel, based on information regarding a contribution rate of the illumination light for the region in light received at the pixel, and based on a calibration parameter for a case where only the illumination light for one of the regions illuminates, the calibration parameter being calculated for the illumination light for each region as a target for distance measurement.

In the first aspect of the present technology, in a distance measuring device configured to illuminate with light selectively one or more regions as targets for distance measurement among a plurality of regions, in a case where two or more of the plurality of regions are illuminated with illumination light for the respective regions, a distance to the region is calculated based on output data output from each pixel of a sensor that receives light from the plurality of regions, the output data corresponding to an amount of light received at the pixel, based on information regarding a contribution rate of the illumination light for the region in light received at the pixel, and based on a calibration parameter for a case where only the illumination light for one of the regions illuminates, the calibration parameter being calculated for the illumination light for each region as a target for distance measurement.

A distance measuring device according to a second aspect of the present technology is configured to illuminate with light selectively one or more regions as targets for distance measurement among a plurality of regions, and includes a recording unit that records information regarding a contribution rate, calculated for each pixel of a sensor that receives light from the plurality of regions, of the illumination light for the region in light received at the pixel, and a calibration parameter for a case where only the illumination light for one of the regions illuminates, the calibration parameter being calculated for the illumination light for each region.

In the second aspect of the present technology, in a distance measuring device configured to illuminate with light selectively one or more regions as targets for distance measurement among a plurality of regions, information regarding a contribution rate, calculated for each pixel of a sensor that receives light from the plurality of regions, of the illumination light for the region in light received at the pixel, and a calibration parameter for a case where only the illumination light for one of the regions illuminates are recorded, the calibration parameter being calculated for the illumination light for each region.

A distance measuring device according to a third aspect of the present technology is configured to illuminate with light selectively one or more regions as targets for distance measurement among a plurality of regions, and includes a computation unit that in a case where two or more of the plurality of regions are illuminated with illumination light for the respective regions, calculates a distance to the region based on output data output from each pixel of a sensor that receives light from the plurality of regions, the output data corresponding to an amount of light received at the pixel, and based on a calibration parameter calculated for the each pixel.

A distance measuring method or a program according to the third aspect of the present technology is for a distance measuring device configured to illuminate with light selectively one or more regions as targets for distance measurement among a plurality of regions, and includes a step of, in a case where two or more of the plurality of regions are illuminated with illumination light for the respective regions, calculating a distance to the region based on output data output from each pixel of a sensor that receives light from the plurality of regions, the output data corresponding to an amount of light received at the pixel, and based on a calibration parameter calculated for the each pixel.

In the third aspect of the present technology, in the distance measuring device configured to illuminate with light selectively one or more regions as targets for distance measurement among a plurality of regions, in a case where two or more of the plurality of regions are illuminated with illumination light for the respective regions, a distance to the region is calculated based on output data output from each pixel of a sensor that receives light from the plurality of regions, the output data corresponding to an amount of light received at the pixel, and based on a calibration parameter calculated for the each pixel.

A distance measuring device according to a fourth aspect of the present technology is configured to illuminate with light selectively one or more regions as targets for distance measurement among a plurality of regions, and includes a recording unit that records a calibration parameter calculated for each pixel of a sensor that receives light from the plurality of regions.

In the fourth aspect of the present technology, in the distance measuring device configured to illuminate with light selectively one or more regions as targets for distance measurement among a plurality of regions, a calibration parameter calculated for each pixel of a sensor that receives light from the plurality of regions is recorded.

### BRIEF DESCRIPTION OF DRAWING

FIG. 1 is a diagram illustrating a ToF distance measuring device that can select a light emitting region.

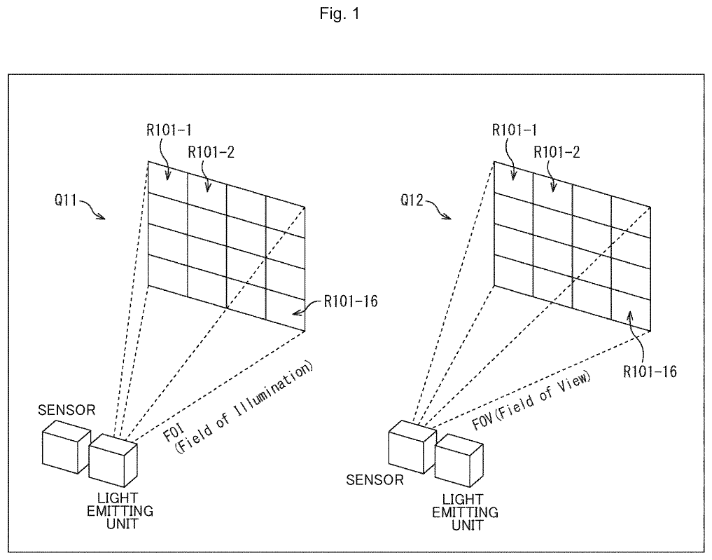

FIG. 2 is a diagram illustrating the ToF distance measuring device that can select a light emitting region.

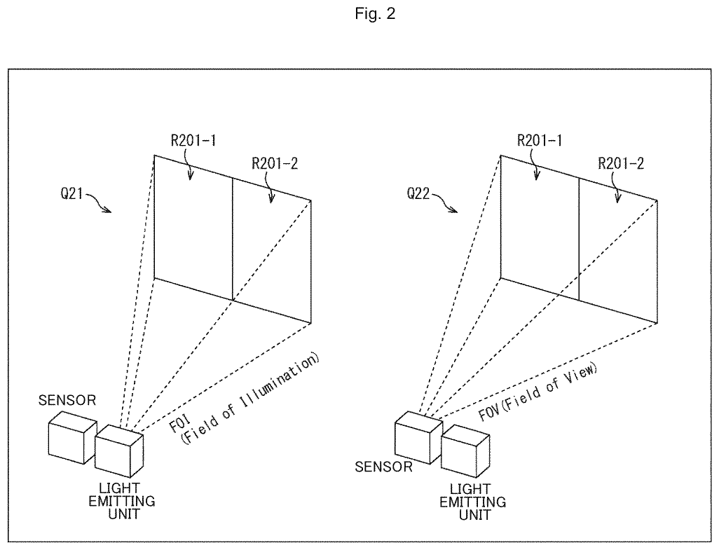

FIG. 3 is a diagram illustrating an ideal ToF distance measuring device that can select a light emitting region.

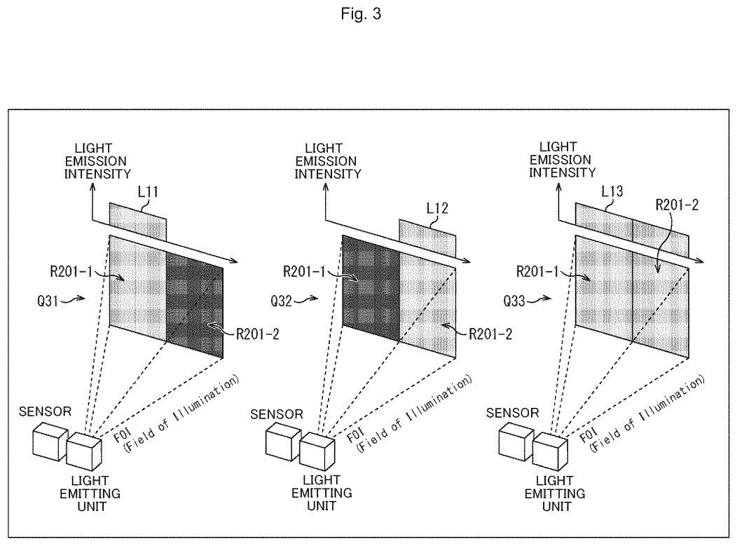

FIG. 4 is a diagram illustrating a practical ToF distance measuring device that can select a light emitting region.

FIG. 5 is a diagram illustrating the practical ToF distance measuring device that can select a light emitting region.

FIG. 6 is a diagram illustrating a configuration example of a ToF distance measuring device.

FIG. 7 is a diagram illustrating a configuration example of a light receiving unit.

FIG. 8 is a flowchart illustrating write processing.

FIG. 9 is a flowchart illustrating distance measurement processing.

FIG. 10 is a flowchart illustrating write processing.

FIG. 11 is a flowchart illustrating distance measurement processing.

FIG. 12 is a diagram illustrating a configuration example of a computer.

FIG. 13 is a block diagram illustrating an example of a schematic configuration of a vehicle control system.

FIG. 14 is an explanatory diagram illustrating an example of installation positions of a vehicle exterior information detecting unit and an imaging unit.

### DESCRIPTION OF EMBODIMENTS

Hereinafter, embodiments of the present technology will be described with reference to the drawings. The present technology is not limited to these embodiments.

### <Configuration Example of ToF Distance Measuring Device>

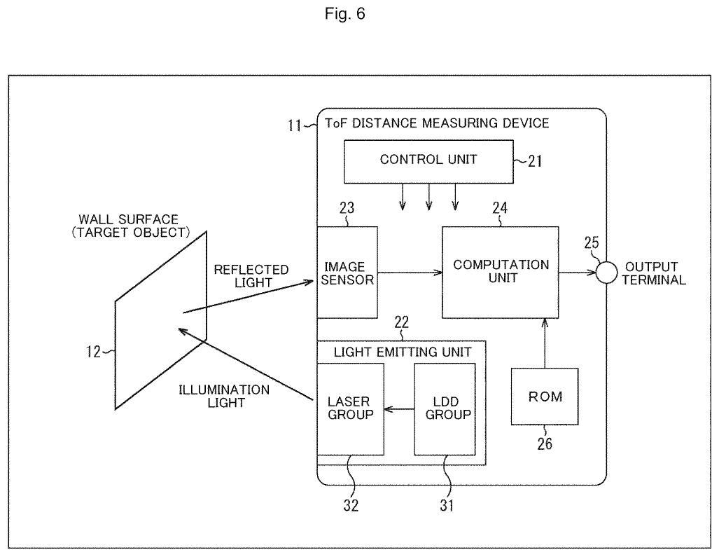

FIG. 6 is a diagram illustrating a configuration example of a ToF distance measuring device to which the present technology is applied.

This ToF distance measuring device 11 measures a distance from the ToF distance measuring device 11 to a wall surface 12 by means of a ToF method in which illumination light (measurement light) illuminates the wall surface 12 which is a target object for distance measurement, and reflected light obtained by the illumination light being reflected by the wall surface 12 is received.

The ToF distance measuring device 11 includes a control unit 21, a light emitting unit 22, an image sensor 23, a computation unit 24, an output terminal 25, and a ROM 26.

The light emitting unit 22 includes an LDD group 31 consisting of a plurality of laser diode drivers (LDDs), and a laser group 32 consisting of a plurality of lasers.

Typically, a lens is attached to the front of the image sensor 23, and this lens collects the reflected light from the wall surface 12, so that each pixel in the image sensor 23 can efficiently receive the reflected light. However, the details of the lens are not related to the spirit of the present technology, and illustration of the lens is therefore omitted.

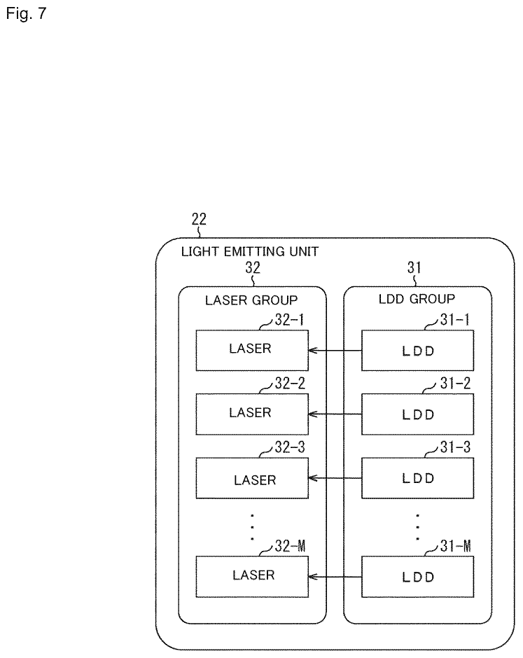

The light emitting unit 22 is configured as illustrated in FIG. 7 in more detail.

In the example of FIG. 7, the light emitting unit 22 includes the LDD group 31 and the laser group 32.

The LDD group 31 consists of M LDDs 31-1 to 31-M, and the laser group 32 consists of M lasers 32-1 to 32-M.

Hereinafter, the LDDs 31-1 and 31-M will also simply be referred to as the LDDs 31 in a case where it is not particularly necessary to distinguish the LDDs 31-1 and 31-M, and the lasers 32-1 and 32-M will also simply be referred to as the lasers 32 in a case where it is not particularly necessary to distinguish the lasers 32-1 and 32-M.

The ToF distance measuring device 11 herein can select any of M regions as light emitting regions as targets for distance measurement. In other words, the ToF distance measuring device 11 can selectively illuminates one or more regions, which are targets for distance measurement among the plurality of M regions, with illumination light.

Each LDD 31-m (m=1 to M) constituting the LDD group 31 is controlled by a control signal supplied from the control unit 21.

The LDD 31-m is a driver for causing the laser 32-m in the laser group 32 to emit light. Accordingly, the control unit 21 can select whether to cause each of the lasers 32-1 to 32-M to independently emit light or not to emit light (to be in a non-light-emitting state).

The respective lasers 32-m (m=1 to M) emit (output) light for distance measurement, that is, the illumination light illustrated in FIG. 6, in different directions.

Returning to the explanation of FIG. 6, the ToF distance measuring device 11 is provided with the ROM 26 that functions as a recording unit and stores (records) calibration parameters for distance measurement.

The image sensor 23 includes a plurality of pixels arranged on a two-dimensional plane, and each pixel includes a light receiving element that receives the reflected light from the wall surface 12 and performs photoelectric conversion on the received reflected light to generate an output corresponding to the amount of the received reflected light.

In the ToF distance measuring device 11, the light emitting unit 22, the image sensor 23, and the computation unit 24 are controlled by control signals from the control unit 21. Specifically, the following control is performed.

First, the control unit 21 transmits a control signal having a frequency of, for example, 10 MHz to the light emitting unit 22 and the image sensor 23.

In response to this control signal from the control unit 21, the light emitting unit 22 outputs light with a 10 MHz sine wave in the direction of some of the M regions.

Thus, each of the LDDs 31 constituting the light emitting unit 22 controls the corresponding laser 32 according to the control signal supplied from the control unit 21, and causes the laser 32 to output light with a 10 MHz sine wave to enter a light emitting state, or causes the laser 32 to enter a non-light-emitting state without outputting light.

As a result, the light (illumination light) from the lasers 32 illuminates the regions (light emitting regions) on the wall surface 12 respectively corresponding to the one or more lasers 32 in the light emitting state.

When the light output from a laser 32 reaches a region on the wall surface 12 corresponding to that laser 32, it is reflected at that region to turn to reflected light and then enters the image sensor 23.

Each pixel of the image sensor 23 performs a light receiving operation at 10 MHz in response to the 10 MHz control signal supplied from the control unit 21.

Specifically, the image sensor 23 receives the light (reflected light) incident from the wall surface 12, that is, the sine wave light, at a period corresponding to a frequency of 10 MHz at each pixel and performs photoelectric conversion on the received light to obtain, for each pixel, output data I_{(u,v)} and output data Q_{(u,v)} corresponding to the amount of light received at the pixel. In other words, the sine wave light output by the laser 32 is detected.

The image sensor 23 supplies (outputs) the output data I_{(u,v)} and the output data Q_{(u,v)} of each pixel obtained by detecting the sine wave light to the computation unit 24.

The output data I_{(u,v)} and the output data Q_{(u,v)} will now be described.

More specifically, the image sensor 23 performs light receiving operations multiple times at different phases (timings). As an example, it is assumed that a light receiving operation is performed at each phase of 0 degrees, 90 degrees, 180 degrees, and 270 degrees, which differ by 90 degrees in a given pixel, and as a result, a light amount value C₀, a light amount value C₉₀, a light amount value C₁₈₀, and a light amount value C₂₇₀, which indicate the amount of light received at the respective phases, are obtained.

In that example, a difference I between the light amount value C₀ and the light amount value C₁₈₀ is set as output data I, and a difference Q between the light amount value C₉₀ and the light amount value C₂₇₀ is set as output data Q.

For example, the position of a pixel (pixel position) on the image sensor 23 is represented by (u, v). This pixel position (u, v) is, for example, coordinates in the u-v coordinate system.

In that example, the difference I and the difference Q obtained for the pixel position (u, v) on the image sensor 23 are output data I_{(u,v)} and output data Q_{(u,v)}, respectively.

When the sine wave light is detected in the image sensor 23 in this way, the computation unit 24 calculates a distance, as described in the above-mentioned NPL 1, based on the sine wave light detected at each pixel, that is, the output data I_{(u,v)} and the output data Q_{(u,v)} obtained for each pixel. At this time, the computation unit 24 also uses the calibration parameters recorded in the ROM 26 to calculate the distance.

In the process of calculating the distance from the ToF distance measuring device 11 (the image sensor 23) to the wall surface 12, the calibration processing described in the above-mentioned NPL 2, that is, the correction based on the calibration parameters is also performed at the same time. For example, in the calibration processing, correction on the sine wave light output by the lasers 32 (circular error correction), and correction on the transmission time of control signals to the pixels of the image sensor 23 (signal propagation delay correction) are made.

The computation unit 24 outputs the result of calculation based on the output data I_{(u,v)} and the output data Q_{(u,v)}, that is, the calculated distance, to the outside via the output terminal 25.

Here, a calibration parameter is assumed to be p. This calibration parameter p means data of about 10 scalar quantities.

Assuming that the distance calculation including the calibration processing using the calibration parameter p is represented by F, a result of calculating a distance for a pixel position (u, v), that is, a distance measurement result L_{(u,v)} is as the following Equation (1). In Equation (1), in the process of calculating the distance, the above-described calibration processing, that is, corrections such as correction on the sine wave light based on the calibration parameter p are also made at the same time.

$$[ Math . 1 ]$$

$${L}_{( u , v )} = F ( u , v , {I}_{( u , v )} , {Q}_{( u , v )} , p ) \qquad ( 1 )$$

In Equation (1), I_{(u,v)} and Q_{(u,v)} are output data I_{(u,v)} and output data Q_{(u,v)} for the pixel position (u, v) output from the image sensor 23, respectively.

The calibration parameter p required for the calibration processing performed by calculation using Equation (1) is stored in the ROM 26. The computation unit 24 reads the necessary calibration parameter p from the ROM 26 to perform the calibration processing (distance calculation).

Next, a first embodiment and a second embodiment to which the present technology is applied will be described below. In any of these embodiments, the corresponding processing is performed by the ToF distance measuring device 11 illustrated in FIG. 6.

### First Embodiment

### <Explanation of Write Processing>

In the following, a case where the region as a target for distance measurement is divided into two, that is, a case where the number M of lasers 32 is two will be described.

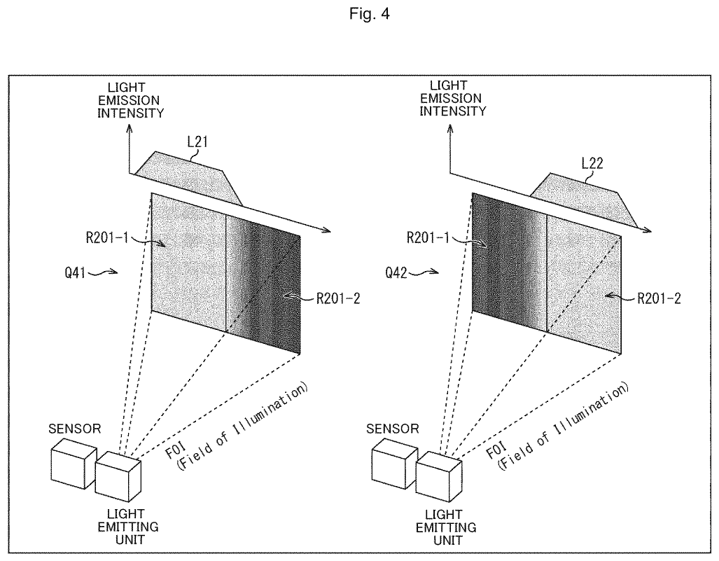

Particularly, for easy understanding, a case will be described below in which the wall surface 12 is divided into the region R201-1 and the region R201-2 as illustrated in FIG. 4, and a distance for at least one of the region R201-1 and the region R201-2 as a target for distance measurement is calculated.

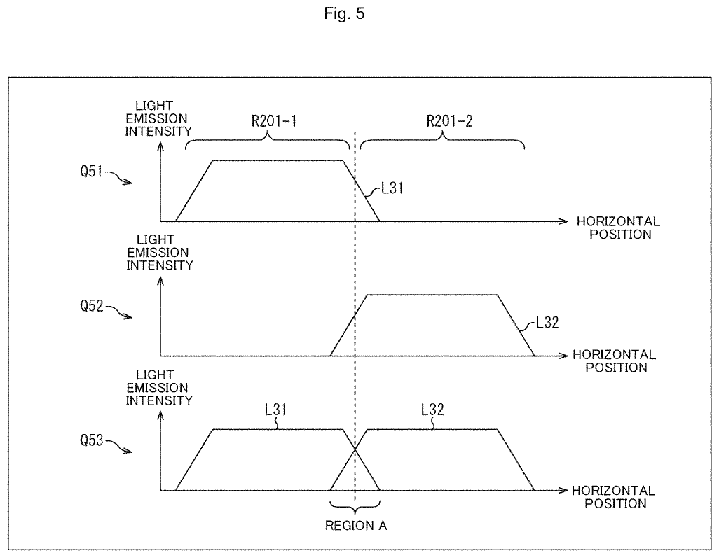

In this case, for example, the region R201-1 is illuminated with the light from the laser 32-1, and the region R201-2 is illuminated with the light from the laser 32-2. The distribution of light emission intensity at the region R201-1 and the region R201-2 is as illustrated in FIG. 5, for example.

In the first embodiment, three calibration parameters are calculated and stored in the ROM 26 prior to actual distance measurement.

Two of the calibration parameters are common to all pixels of the image sensor 23, and the remaining one calibration parameter has a value depending on each pixel of the image sensor 23, that is, a value for each pixel position (u, v).

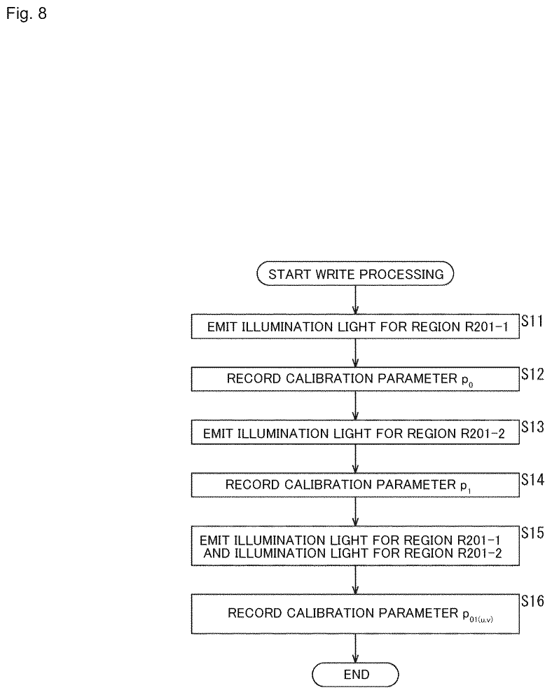

First, write processing in which three calibration parameters are calculated and the calibration parameters are written into the ROM 26 will be described with reference to the flowchart of FIG. 8. This write processing is performed using existing measuring equipment (a calibration device) when the ToF distance measuring device 11 is shipped.

In step S11, the control unit 21 supplies a control signal to the LDD 31-1 to control the LDD 31-1, thereby causing the laser 32-1 to emit (output) illumination light for the region R201-1, and supplies a control signal to each pixel of the sensor 23 to cause the pixel to perform a light receiving operation. In this case, the wall surface 12 is illuminated with only the illumination light for the region R201-1.

The computation unit 24 calculates a distance, that is, a distance measurement result L_{(u,v)}, by using the output data I_{(u,v)} and the output data Q_{(u,v)} of each pixel position (u, v), which are supplied from the image sensor 23, and the pixel position (u, v), and outputs the calculation result to the calibration device via the output terminal 25. At this time, the distance measurement result L_{(u,v)} is calculated without using the calibration parameter(s).

The calibration device performs calibration based on the distance measurement result L_{(u,v)} for each pixel position (u, v), supplied from the computation unit 24, and the actual distance (true value of distance) prepared in advance, thereby calculating a common calibration parameter p₀ for all pixel positions (u, v). As the calibration device, an existing device may be used.

The calibration device supplies the calibration parameter p₀ obtained as the calibration result to the ROM 26 from an input terminal or the like of the ToF distance measuring device 11 via the control unit 21. The calibration parameter p₀ may be directly supplied to the ROM 26 from the input terminal or the like.

In step S12, the ROM 26 records the calibration parameter p₀ supplied from the calibration device. Thus, the calibration parameter p₀ is stored in the ROM 26. This calibration parameter p₀ is a calibration parameter for a case where only the illumination light for the region R201-1 illuminates the wall surface 12, and corresponds to the above-described calibration parameter p.

In step S13, the control unit 21 supplies a control signal to the LDD 31-2 to cause the laser 32-2 to emit (output) illumination light for the region R201-2, and supplies a control signal to each pixel of the sensor 23 to cause the pixel to perform a light receiving operation. In this case, the wall surface 12 is illuminated with only the illumination light for the region R201-2.

The computation unit 24 calculates a distance (a distance measurement result L_{(u,v)}) by using the output data I_{(u,v)} and the output data Q_{(u,v)} of each pixel position (u, v), which are supplied from the image sensor 23, and the pixel position (u, v), without using any calibration parameter, and outputs the calculation result to the calibration device via the output terminal 25.

The calibration device performs calibration based on the distance measurement result L_{(u,v)} for each pixel position (u, v), supplied from the computation unit 24, and the actual distance prepared in advance, thereby calculating a common calibration parameter p₁ for all pixel positions (u, v).

The calibration device supplies the calibration parameter p₁ obtained as the calibration result to the ROM 26 via the control unit 21 of the ToF distance measuring device 11 or the like.

In step S14, the ROM 26 records the calibration parameter p₁ supplied from the calibration device. This calibration parameter p₁ is a calibration parameter for a case where only the illumination light for the region R201-2 illuminates the wall surface 12, and corresponds to the above-described calibration parameter p.

In step S15, the control unit 21 supplies a control signal to the LDD 31-1 and the LDD 31-2 to cause the laser 32-1 to emit illumination light for the region R201-1 and to cause the laser 32-2 to emit illumination light for the region R201-2. The control unit 21 also supplies a control signal to each pixel of the image sensor 23 to cause the pixel to perform a light receiving operation. In this case, the wall surface 12 is illuminated with both the illumination light for the region R201-1 and the illumination light for the region R201-2.

The computation unit 24 calculates a distance (a distance measurement result L_{(u,v)}) by using the output data I_{(u,v)} and the output data Q_{(u,v)} of each pixel position (u, v), which are supplied from the image sensor 23, and the pixel position (u, v), without using any calibration parameter, and outputs the calculation result to the calibration device via the output terminal 25.

The calibration device performs calibration based on the distance measurement result L_{(u,v)} for each pixel position (u, v), supplied from the computation unit 24, and the actual distance prepared in advance, thereby calculating a calibration parameter p_{01(u,v)} for each pixel position (u, v).

In this case, both the illumination light for the region R201-1 and the illumination light for the region R201-2 illuminates, that is, both the region R201-1 and the region R201-2 emit light, and accordingly the distribution of light emission intensity at the region R201-2 and the region R201-1 (wall surface 12) is as illustrated by the arrow Q53 in FIG. 5.

Therefore, in the region A portion around the boundary between the region R201-1 and the region R201-2, the reflected light received depending on the pixel position (u, v), that is, a combined wave of the illumination light for the region R201-1 and the illumination light for the region R201-2 has a different waveform.

Therefore, in step S15, a calibration parameter p_{01(u,v)} corresponding to the above-described calibration parameter p is calculated for each pixel position (u, v). This calibration parameter p_{01(u,v)} is a calibration parameter for a case where the wall surface 12 is illuminated with both the illumination light for the region R201-1 and the illumination light for the region R201-2.

The calibration device supplies the calibration parameter p_{01(u,v)} for each pixel position (u, v) obtained as the calibration result to the ROM 26 via the control unit 21 of the ToF distance measuring device 11 or the like.

In step S16, the ROM 26 records the calibration parameters p_{01(u,v)} supplied from the calibration device.

When the calibration parameter p₀, the calibration parameter p₁, and the calibration parameter p_{01(u,v)} are stored (written) in the ROM 26 in this way, the write processing ends.

As a result, all the calibration parameters necessary for the calibration processing performed for calculating a distance at the actual distance measurement are stored in the ROM 26.

As described above, the ToF distance measuring device 11 receives calibration parameters from the calibration device for each combination of lasers 32 to emit light, that is, for each light emission pattern of the laser group 32, and records these calibration parameters in the ROM 26. By doing so, the ToF distance measuring device 11, which can select a region to be illuminated with light from a laser 32 (light emitting region), can perform appropriate calibration processing when distance measurement is actually performed.

### <Explanation of Distance Measurement Processing>

Next, processing performed for actual distance measurement will be described.

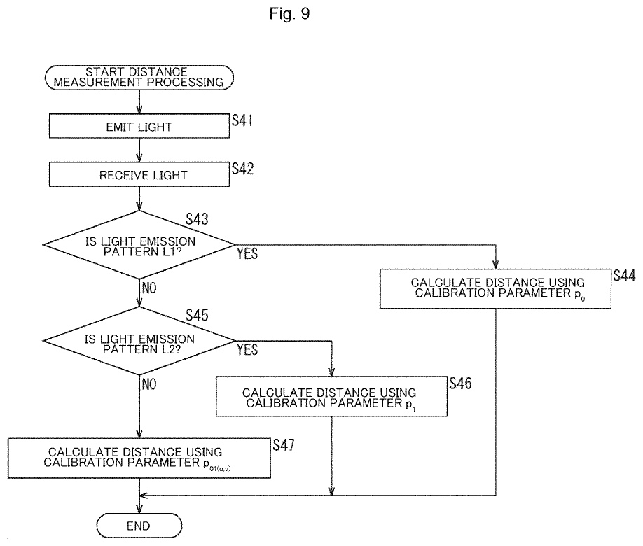

Specifically, the distance measurement processing performed by the ToF distance measuring device 11 will be described below with reference to a flowchart in FIG. 9.

In step S41, the control unit 21 supplies a control signal to the LDD 31 to cause the corresponding laser 32 to emit light.

It is now assumed that the control unit 21 can select any one of light emission patterns L1 to L3 as a light emission pattern for the laser group 32.

In the light emission pattern L1, only the laser 32-1 emits light, that is, only the illumination light for the region R201-1 is output, and in the light emission pattern L2, only the laser 32-2 emits light, that is, the illumination light for the region R201-2 is output. In the light emission pattern L3, the lasers 32-1 and 32-2 emit light, that is, both the illumination light for the region R201-1 and the illumination light for the region R201-2 are output.

The control unit 21 supplies to the LDD group 31 a control signal corresponding to the selected light emission pattern so that the laser group 32 emits light in the selected light emission pattern, and also supplies information indicating the light emission pattern to the computation unit 24.

Each LDD 31 controls the corresponding laser 32 as appropriate according to the control signal supplied from the control unit 21 to cause the laser 32 to output light.

In step S42, the control unit 21 supplies a control signal to the image sensor 23 to cause the image sensor 23 to receive the reflected light from the wall surface 12.

When receiving the reflected light, the image sensor 23 supplies output data I_{(u,v)} and output data Q_{(u,v)} of each pixel position (u, v) corresponding to the amount of reflected light to the computation unit 24.

The computation unit 24 identifies the light emission pattern for the laser group 32 based on the information supplied from the control unit 21.

Specifically, in step S43, the computation unit 24 determines whether or not the light emission pattern is the light emission pattern L1 based on the information supplied from the control unit 21.

If it is determined in step S43 that the light emission pattern is L1, the computation unit 24 reads the common calibration parameter p₀ for all pixel positions (u, v) corresponding to the light emission pattern L1 from the ROM 26, and then the processing proceeds to step S44.

In step S44, the computation unit 24 calculates a distance (distance measurement result L_{(u,v)}) for each pixel position (u, v) based on the output data I_{(u,v)} and the output data Q_{(u,v)}, which are supplied from the image sensor 23, the pixel position (u, v), and the calibration parameter p₀.

Specifically, the computation unit 24 calculates the above Equation (1) using the calibration parameter p₀ as the calibration parameter p to calculate the distance measurement result L_{(u,v)} for each pixel position (u, v), and outputs the resulting distance measurement result L_{(u,v)} to the outside via the output terminal 25. When the distance measurement result L_{(u,v)} is thus output, the distance measurement processing ends.

If it is determined in step S43 that the light emission pattern is not L1, the computation unit 24 determines in step S45 whether or not the light emission pattern is the light emission pattern L2 based on the information supplied from the control unit 21.

If it is determined in step S45 that the light emission pattern is L2, the computation unit 24 reads the common calibration parameter p₁ for all pixel positions (u, v) corresponding to the light emission pattern L2 from the ROM 26, and then the processing proceeds to step S46.

In step S46, the computation unit 24 calculates a distance (distance measurement result L_{(u,v)}) for each pixel position (u, v) based on the output data I_{(u,v)} and the output data Q_{(u,v)}, which are supplied from the image sensor 23, the pixel position (u, v), and the calibration parameter p₁.

Specifically, the computation unit 24 calculates Equation (1) using the calibration parameter p₁ as the calibration parameter p to calculate the distance measurement result L_{(u,v)} for each pixel position (u, v), and outputs the resulting distance measurement result L_{(u,v)} to the outside via the output terminal 25. When the distance measurement result L_{(u,v)} is output, the distance measurement processing ends.

If it is determined in step S45 that the light emission pattern is not L2, that is, if the light emission pattern is L3, the computation unit 24 reads the calibration parameter p_{01(u,v)} for each pixel position (u, v) corresponding to the light emission pattern L3 from the ROM 26, and then the process proceeds to step S47.

In step S47, the computation unit 24 calculates a distance (distance measurement result L_{(u,v)}) for each pixel position (u, v) based on the output data I_{(u,v)} and the output data Q_{(u,v)}, which are supplied from the image sensor 23, the pixel position (u, v), and the calibration parameter p_{01(u,v)}.

Specifically, the computation unit 24 calculates Equation (1) using the calibration parameter p_{01(u,v)} as the calibration parameter p to calculate the distance measurement result L_{(u,v)} for each pixel position (u, v), and outputs the resulting distance measurement result L_{(u,v)} to the outside via the output terminal 25. When the distance measurement result L_{(u,v)} is output, the distance measurement processing ends.

As described above, the ToF distance measuring device 11 calculates a distance to the wall surface 12 as the target for distance measurement by using the calibration parameter corresponding to the light emission pattern.

By doing this, for the ToF distance measuring device 11 that can select a region (light emitting region) to be illuminated with the light from the laser 32, it is possible to perform appropriate calibration processing according to the light emission pattern when a distance measurement result L_{(u,v)}, that is, a distance to the wall surface 12, is calculated. This makes it possible to provide more accurate distance measurement.

In particular, when measuring a distance using the light emission pattern L3 in which both the illumination light for the region R201-1 and the illumination light for the region R201-2 illuminate, the ToF distance measuring device 11 can perform optimal calibration processing for each pixel position (u, v) because the calibration parameter p_{01(u,v)} corresponding to the pixel position (u, v) is used.

### Second Embodiment

### <Parameters to be Stored in ROM>

In the first embodiment, in order to perform distance measurement using the light emission pattern L3 in which both the illumination light for the region R201-1 and the illumination light for the region R201-2 illuminate, a number of calibration parameters p_{01(u,v)} are required for the number of pixels of the image sensor 23.

In this respect, a second embodiment is configured to reduce the total capacity of recording region of the ROM 26 in which the calibration parameters are recorded.

As in the case of the first embodiment, a case will be described below in which the wall surface 12 is divided into the region R201-1 and the region R201-2 as illustrated in FIG. 4, and a distance for at least one of the region R201-1 and the region R201-2 as a target for distance measurement is calculated.

In the second embodiment, the calibration parameter p₀ for a case where only the region R201-1 is illuminated with light, that is, for a case of using the light emission pattern L1 and the calibration parameter p₁ for a case where only the region R201-2 is illuminated with light, that is, for a case of using the light emission pattern L2, are stored in the ROM 26 in advance. These calibration parameters p₀ and calibration parameters p₁ are the same as those in the first embodiment.

Stored in the ROM 26 in advance is also data on a ratio between the illumination light for the region R201-1 (the light illuminating the region R201-1) and the illumination light for the region R201-2, which form a combined wave to be received at each pixel position (u, v) in a case where both the region R201-1 and the region R201-2 are illuminated with light, that is, in a case of using the light emission pattern L3.

Here, the data on the ratio between the illumination light for the region R201-1 and the illumination light for the region R201-2, which form a combined wave, includes, for example, for each pixel position (u, v), received light intensity information C_{0(u,v)} of the illumination light for the region R201-1 and received light intensity information C_{1(u,v)} of the illumination light for the region R201-2.

Now let C_{0(u,v)} be the intensity of the illumination light for the region R201-1 received by the pixel at a pixel position (u, v), and let C_{1(u,v)} be the intensity of the illumination light for the region R201-2 received by the pixel at the pixel position (u, v).

In this case, the ratio between the illumination light for the region R201-1 and the illumination light for the region R201-2 in the combined wave (reflected light) received by the pixel at the pixel position (u, v) is C_{0(u,v)}:C_{1(u,v)}. Therefore, the received light intensity information C_{0(u,v)} and the received light intensity information C_{1(u,v)} are information indicating contribution rates (information regarding a contribution rate) of the illumination light for the region R201-1 and the illumination light for the region R201-2 with respect to the combined wave (light) received by the pixel at the pixel position (u, v), respectively.

As described above, the calibration parameter p₀ and the calibration parameter p₁ are data of about 10 scalar quantities.

On the other hand, the received light intensity information C_{0(u,v)} and the received light intensity information C_{1(u,v)}, by which the ratio of the two illumination light rays is indicated, are data of two scalar quantities in total.

Therefore, in the second embodiment, the amount of data stored in advance in the ROM 26 corresponds to scalar quantities of approximately “20+2×(number of pixels of image sensor 23)”, which makes it possible to save the capacity of the ROM 26 as compared to scalar quantities of approximately “10×(number of pixels of image sensor 23)”. In other words, as compared to the first embodiment that requires to store data of scalar quantities of approximately “20+10×(number of pixels of the image sensor 23)” in the ROM 26, the second embodiment makes it possible to significantly reduce the amount of data required to be recorded.

Next, processing will be described for distance measurement performed by the ToF distance measuring device 11 with the calibration parameter p₀, the calibration parameter p₁, the received light intensity information C_{0(u,v)}, and the received light intensity information C_{1(u,v)} stored in the ROM 26.

First, in the case where only the region R201-1 is illuminated with light, that is, in the case of using the light emission pattern L1, the computation unit 24 reads the calibration parameter p₀ from the ROM 26.

Then, the computation unit 24 calculates the following Equation (2) for each pixel position (u, v) based on the output data I_{(u,v)} and the output data Q_{(u,v)}, which are supplied from the image sensor 23, the pixel position (u, v), and the calibration parameter p₀ to calculate a distance measurement result L_{(u,v)}. Equation (2) is for calculation similar to the above Equation (1), and in that calculation process, calibration processing, that is, correction based on the calibration parameters is also performed at the same time.

$$[ Math . 2 ]$$

$${L}_{( u , v )} = F ( u , v , {I}_{( u , v )} , {Q}_{( u , v )} , {p}_{0} ) \qquad ( 2 )$$

In the case where only the region R201-2 is illuminated with light, that is, in the case of using the light emission pattern L2, the computation unit 24 reads the calibration parameter p₁ from the ROM 26.

Then, the computation unit 24 calculates the following Equation (3) for each pixel position (u, v) based on the output data I_{(u,v)} and the output data Q_{(u,v)}, which are supplied from the image sensor 23, the pixel position (u, v), and the calibration parameter p₁ to calculate a distance measurement result L_{(u,v)}. Equation (3) is for calculation similar to the above Equation (1), and in that calculation process, calibration processing, that is, correction based on the calibration parameters is also performed at the same time.

$$[ Math . 3 ]$$

$${L}_{( u , v )} = F ( u , v , {I}_{( u , v )} , {Q}_{( u , v )} , {p}_{1} ) \qquad ( 3 )$$

In the case where both the region R201-1 and the region R201-2 are illuminated with light, that is, in the case of using the light emission pattern L3, the computation unit 24 reads the calibration parameter p₀, the calibration parameter p₁, the received light intensity information C_{0(u,v)}, and the received light intensity information C_{1(u,v)} from the ROM 26.

The computation unit 24 then calculates, for each pixel position (u, v), a distance measurement result L_{(u,v)} that satisfies simultaneous equations of the following Equations (4) to (8) based on the output data I_{(u,v)} and the output data Q_{(u,v)}, which are supplied from the image sensor 23, the pixel position (u, v), the calibration parameter p₀, the calibration parameter p₁, the received light intensity information C_{0(u,v)}, and the received light intensity information C_{1(u,v)}. In other words, the computation unit 24 calculates a distance measurement result L_{(u,v)} by solving the simultaneous equations of the following Equations (4) to (8).

$$[ Math . 4 ]$$

$${L}_{( u , v )} = F ( u , v , {I}_{0 ( u , v )} , {Q}_{0 ( u , v )} , {p}_{0} ) \qquad ( 4 )$$

$$[ Math . 5 ]$$

$${L}_{( u , v )} = F ( u , v , {I}_{1 ( u , v )} , {Q}_{1 ( u , v )} , {p}_{1} ) \qquad ( 5 )$$

$$[ Math . 6 ]$$

$${Q}_{( u , v )} = {Q}_{0 ( u , v )} + {{Q}_{1}}_{( u , v )} \qquad ( 6 )$$

$$[ Math . 7 ]$$

$${I}_{( u , v )} = {I}_{0 ( u , v )} + {I}_{1 ( u , v )} \qquad ( 7 )$$

$$[ Math . 8 ]$$

$$\frac{{w}_{1} \cdot {C}_{1 ( u , v )}}{{w}_{0} \cdot {C}_{0 ( u , v )}} = \frac{\sqrt{{( {I}_{1 ( u , v )} )}^{2} + {( {Q}_{1 ( u , v )} )}^{2}}}{\sqrt{{( {I}_{0 ( u , v )} )}^{2} + {( {Q}_{0 ( u , v )} )}^{2}}} \qquad ( 8 )$$

In Equation (8), w₀ and w₁ are parameters for adjusting the amount of light (illumination light) output from the laser 32 in actual distance measurement. These w₀ and w₁ will be referred to as light emission intensity adjustment values below.

For example, the light emission intensity adjustment value w₀ is set to any value from 0 to 100 indicating the amount of illumination light for the region R201-1. In particular, the light emission intensity adjustment value w₀ indicates a light emission intensity of the illumination light for the region R201-1 to be actually output based on a maximum light emission intensity (light amount) of 100 of the illumination light for the region R201-1.

Similarly, the light emission intensity adjustment value w₁ indicates an amount of illumination light for the region R201-2, and is any value from 0 to 100 indicating a light emission intensity of the illumination light for the region R201-2 to be actually output based on a maximum light emission intensity (light amount) of 100 of the illumination light for the region R201-2, for example.

The light emission intensity adjustment value w₀ and the light emission intensity adjustment value w₁ are set by the control unit 21. The light emission intensity adjustment value w₀ and the light emission intensity adjustment value w₁ are described in, for example, the above-mentioned PTL 2.

Equations (4) to (8) will now be described.

In the case where both the illumination light for the region R201-1 and the illumination light for the region R201-2 are emitted, the light (reflected light) received by each pixel of the image sensor 23 is a combined wave. One component of the combined wave is the illumination light for the region R201-1, and the other component is the illumination light for the region R201-2.

In the light received by the pixel at a pixel position (u, v) in the image sensor 23, the output based on the component of the illumination light for the region R201-1 is referred to as output data I_{0(u,v)} and output data Q_{0(u,v)}, and the output based on the component of the illumination light for the region R201-2 is referred to as output data I_{1(u,v)} and output data Q_{1(u,v)}.

Since the calibration parameter for the case where only the illumination light for the region R201-1 is used for distance measurement is p₀, Equation (4) holds. Similarly, since the calibration parameter for the case where only the illumination light for the region R201-2 is used is p₁, Equation (5) holds.

In the case where both the illumination light for the region R201-1 and the illumination light for the region R201-2 are used (emitted) for distance measurement, the light received by each pixel of the image sensor 23 is a combined wave of the illumination light for the region R201-1 and the illumination light for the region R201-2.

Therefore, the above Equations (6) and (7) hold, where the output from the pixel at each pixel position (u, v) in actual distance measurement, that is, the observed values of light at the pixel, is output data I_{(u,v)} and output data Q_{(u,v)}.

A value obtained by adding the square value of the output data I_{(u,v)} (the square value of a difference I) and the square value of the output data Q_{(u,v)} (the square value of a difference Q) and then taking the square root of the resulting sum is the intensity of light received by the pixel at the pixel position (u,v). This is described, for example, in Equation (27) of NPL 1.

In actual distance measurement, the illumination light for the region R201-1 is output with a light emission intensity indicated by the light emission intensity adjustment value w₀, and the light illumination for the region R201-2 is output with a light emission intensity indicated by the light emission intensity adjustment value w₁.

Therefore, the ratio between the intensity of the illumination light for the region R201-1 and the intensity of the illumination light for the region R201-2, which are received by the pixel at each pixel position (u, v), is “w₀×C_{0(u,v)}”: “w₁λC_{1(u,v)}”, and accordingly, the above Equation (8) holds.

Equations (4) to (8) are as described above.

The unknowns in Equations (4) to (8) are the distance measurement result L_{(u,v)}, output data I_{0(u,v)}, output data Q_{0(u,v)}, output data I_{1(u,v)}, and output data Q_{1(u,v)}. Thus, by solving the simultaneous equations of Equations (4) to (8), these unknowns can be obtained and the resulting distance measurement result L_{(u,v)} can be output. In this case as well, as in the case of the above Equation (1), calibration processing, that is, correction based on the calibration parameters, is also performed at the same time in the calculation process to calculate a distance (distance measurement result L_{(u,v)}).

### <Explanation of Write Processing>

Next, write processing in the second embodiment will be described.

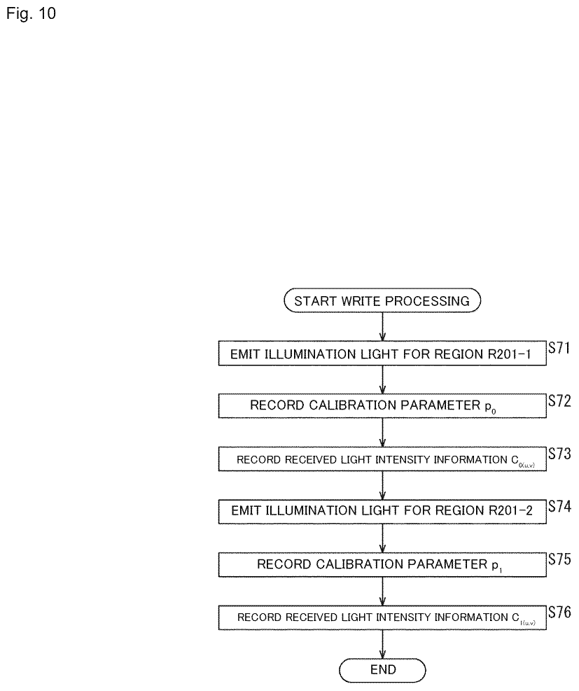

Specifically, write processing in which the calibration parameters and the like are written into the ROM 26 will be described below with reference to a flowchart of FIG. 10.

In step S71, the control unit 21 supplies a control signal to the LDD 31-1 to control the LDD 31-1, thereby causing the laser 32-1 to emit (output) illumination light for the region R201-1, and supplies a control signal to each pixel of the sensor 23 to cause the pixel to perform a light receiving operation. Thus, light is emitted in the light emission pattern L1.

In this case, the control unit 21 sets the light emission intensity adjustment value w₀=100, controls the LDD 31-1 so that the laser 32-1 outputs light at the maximum light emission intensity, and accordingly, the wall surface 12 is illuminated with only the illumination light for the region R201-1.

The computation unit 24 calculates a distance (a distance measurement result L_{(u,v)}) by using the output data I_{(u,v)} and the output data Q_{(u,v)} of each pixel position (u, v), which are supplied from the image sensor 23, and the pixel position (u, v), without using any calibration parameter, and outputs the calculation result to the calibration device via the output terminal 25.

The calibration device performs calibration based on the distance measurement result L_{(u,v)} for each pixel position (u, v), supplied from the computation unit 24, and the actual distance (true value of distance) prepared in advance, thereby calculating a common calibration parameter p₀ for all pixel positions (u, v). As the calibration device, an existing device may be used.

The calibration device supplies the calibration parameter p₀ obtained as the calibration result to the ROM 26 from an input terminal or the like of the ToF distance measuring device 11 via the control unit 21.

In step S72, the ROM 26 records the calibration parameter p₀ supplied from the calibration device.

In step S73, the ROM 26 records a value, Confidence at each pixel position (u, v) as received light intensity information C_{0(u,v)}.

For example, the computation unit 24 calculates as Confidence a value obtained by adding the square value of the output data I_{(u,v)} and the square value of the output data Q_{(u,v)} and then taking the square root of the resulting sum based on the output data I_{(u,v)} and the output data Q_{(u,v)} obtained in step S71. Then, the computation unit 24 supplies the calculated Confidence value, that is, the intensity of the received light, to the ROM 26 where that value is recorded as received light intensity information C_{0(u,v)}.

Confidence is described in Equation (27) of NPL 1, for example. The calculation of the received light intensity information C_{0(u,v)} is not limited to being performed by the computation unit 24, and may be performed by the control unit 21, or may be performed by the calibration device.

In step S74, the control unit 21 supplies a control signal to the LDD 31-2 to cause the laser 32-2 to emit (output) illumination light for the region R201-2, and supplies a control signal to each pixel of the sensor 23 to cause the pixel to perform a light receiving operation. Thus, light is emitted in the light emission pattern L2.

In this case, the control unit 21 sets the light emission intensity adjustment value w₁=100, controls the LDD 31-2 so that the laser 32-2 outputs light at the maximum light emission intensity, and accordingly, the wall surface 12 is illuminated with only the illumination light for the region R201-2.

The computation unit 24 calculates a distance (a distance measurement result L_{(u,v)}) by using the output data I_{(u,v)} and the output data Q_{(u,v)} of each pixel position (u, v), which are supplied from the image sensor 23, and the pixel position (u, v), without using any calibration parameter, and outputs the calculation result to the calibration device via the output terminal 25.

The calibration device performs calibration based on the distance measurement result L_{(u,v)} for each pixel position (u, v), supplied from the computation unit 24, and the actual distance prepared in advance, thereby calculating a common calibration parameter p₁ for all pixel positions (u, v).

The calibration device supplies the calibration parameter p₁ obtained as the calibration result to the ROM 26 via the control unit 21 of the ToF distance measuring device 11 or the like.

In step S75, the ROM 26 records the calibration parameter p₁ supplied from the calibration device.

In step S76, the ROM 26 records a value, Confidence at each pixel position (u, v) as received light intensity information C_{1(u,v)}.

Specifically, in step S76, as in step S73, the computation unit 24 calculates Confidence based on the output data I_{(u,v)} and the output data Q_{(u,v)} obtained in step S74, and causes the ROM 26 to record the Confidence value as received light intensity information C_{1(u,v)}.

When the calibration parameter p₀, the calibration parameter p₁, the received light intensity information C_{0(u,v)}, and the received light intensity information C_{1(u,v)} are stored (written) in the ROM 26 in this way, the write processing ends.

As a result, all the calibration parameters and the like necessary for the calibration processing performed for calculating a distance at the actual distance measurement are stored in the ROM 26.

As described above, the ToF distance measuring device 11 records in the ROM 26 the calibration parameter p₀ and the received light intensity information C_{0(u,v)}, which are calculated for the light emission pattern L1, and the calibration parameter p₁ and the received light intensity information C_{1(u,v)}, which are calculated for the light emission pattern L2.

By doing this, for the ToF distance measuring device 11 that can select a region (light emitting region) to be illuminated with the light from the laser 32, it is possible to perform appropriate calibration processing at actual distance measurement. Particularly in this case, since it is not necessary to hold calibration parameters for all light emission patterns, the amount of data required to be recorded in the ROM 26 can be reduced.

### <Explanation of Distance Measurement Processing>

Next, processing performed for actual distance measurement will be described.

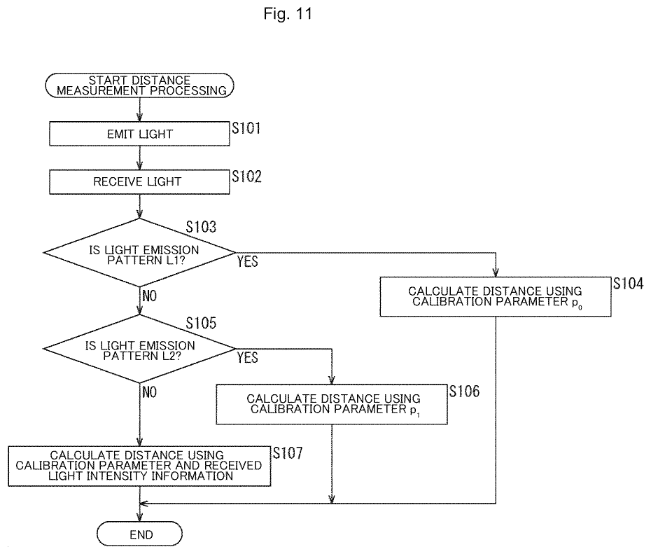

Specifically, the distance measurement processing performed by the ToF distance measuring device 11 will be described below with reference to a flowchart in FIG. 11.

The processing of step S101 and step S102 is the same as the processing of step S41 and step S42 in FIG. 9, and thus description thereof will be omitted.

However, in step S101, the control unit 21 determines a light emission intensity adjustment value for each laser 32 to emit light according to the selected light emission pattern and the like, and controls the LDD 31 so that the laser 32 emits light with a light emission intensity indicated by the light emission intensity adjustment value.

When the processing of step S101 and step S102 is performed, the computation unit 24 identifies the light emission pattern for the laser group 32 based on the information supplied from the control unit 21.

In step S103, the computation unit 24 determines whether or not the light emission pattern is the light emission pattern L1 based on the information supplied from the control unit 21.

If it is determined in step S103 that the light emission pattern is L1, the computation unit 24 reads the common calibration parameter p₀ for all pixel positions (u, v) corresponding to the light emission pattern L1 from the ROM 26, and then the processing proceeds to step S104.

In step S104, the computation unit 24 calculates a distance (distance measurement result L_{(u,v)}) for each pixel position (u, v) by using the above Equation (2) based on the output data I_{(u,v)} and the output data Q_{(u,v)}, which are supplied from the image sensor 23, the pixel position (u, v), and the calibration parameter p₀.

The computation unit 24 outputs the resulting distance measurement result L_{(u,v)} to the outside via the output terminal 25, and then the distance measurement processing ends.

If it is determined in step S103 that the light emission pattern is not L1, the computation unit 24 determines in step S105 whether or not the light emission pattern is the light emission pattern L2 based on the information supplied from the control unit 21.

If it is determined in step S105 that the light emission pattern is L2, the computation unit 24 reads the common calibration parameter p₁ for all pixel positions (u, v) corresponding to the light emission pattern L2 from the ROM 26, and then the processing proceeds to step S106.

In step S106, the computation unit 24 calculates a distance (distance measurement result L_{(u,v)}) for each pixel position (u, v) by using the above Equation (3) based on the output data I_{(u,v)} and the output data Q_{(u,v)}, which are supplied from the image sensor 23, the pixel position (u, v), and the calibration parameter p₁.

The computation unit 24 outputs the resulting distance measurement result L_{(u,v)} to the outside via the output terminal 25, and then the distance measurement processing ends.

If it is determined in step S105 that the light emission pattern is not L2, that is, if the light emission pattern is L3, the processing proceeds to step S107.

In this case, the computation unit 24 reads the calibration parameter p₀, the calibration parameter p₁, the received light intensity information C_{0(u,v)}, and the received light intensity information C_{1(u,v)} from the ROM 26. The computation unit 24 also acquires from the control unit 21 the light emission intensity adjustment value w₀ and the light emission intensity adjustment value w₁ at the time of light emission in step S101.

In step S107, the computation unit 24 calculates a distance (distance measurement result L_{(u,v)}) for each pixel position (u, v) by using the calibration parameters and the received light intensity information, which are read from the ROM 26.

Specifically, the computation unit 24 solves the simultaneous equations of Equations (4) to (8) based on the output data I_{(u,v)} and the output data Q_{(u,v)}, which are supplied from the image sensor 23, the pixel position (u, v), the calibration parameter p₀, the calibration parameter p₁, the received light intensity information C_{0(u,v)}, the received light intensity information C_{1(u,v)}, and the light emission intensity adjustment value w₀ and the light emission intensity adjustment value w₁.

As a result, the distance measurement results L_{(u,v)}, the output data I_{0(u,v)}, the output data Q_{0(u,v)}, the output data I_{1(u,v)}, and the output data Q_{1(u,v)}, which are the unknowns in Equations (4) to (8), are found.

The computation unit 24 outputs the distance measurement result L_{(u,v)} thus obtained for each pixel position (u, v) to the outside via the output terminal 25, and then the distance measurement processing ends.

As described above, the ToF distance measuring device 11 calculates a distance to the wall surface 12 as the target for distance measurement by using the calibration parameters and the received light intensity information according to the light emission pattern.

By doing this, for the ToF distance measuring device 11 that can select a region (light emitting region) to be illuminated with the light from the laser 32, it is possible to perform appropriate calibration processing according to the light emission pattern when a distance to the wall surface 12 is calculated. This makes it possible to provide more accurate distance measurement.

In particular, since in the ToF distance measuring device 11, there is no need to prepare calibration parameters p_{01(u,v)} for each pixel position (u, v) for distance measurement using the light emission pattern L3, the amount of data required to be recorded in the ROM 26 can be reduced.

### <Generalized Case>

Incidentally, in the above description of the second embodiment, a case where the wall surface 12 is divided into two regions R201-1 and R201-2, that is, a case where the number M of lasers 32 and the number M of LDDs 31 are each two has been described. However, the following case, which will be described, is a generalized case.

It is now assumed that when light is output by a certain laser 32-m (where m=1 to M) among the M lasers 32, the light illuminates a region R201-m on the wall surface 12 corresponding to the laser 32-m. In other words, the laser 32-m outputs illumination light for the region R201-m.

In calibration, that is, in the write processing, the M lasers 32, that is, the M regions R201 are made to emit light one by one, and the calibration is performed by the calibration device in the same manner as in step S71 and step S72 of FIG. 10.

In calibration, the laser 32-m is controlled so that the light emission intensity adjustment value is set to 100 to emit light at the maximum emission intensity. In this case as well, as the calibration device, an existing device may be used.

Now let pₘ₋₁ be a common calibration parameter for all pixel positions (u, v) obtained by emitting only one laser 32-m (where m=1 to M) to perform calibration.

This calibration parameter pₘ₋₁ is a calibration parameter obtained for the illumination light for the region R201-m output by the laser 32-m, for a case where there is only one light emitting region, the region R201-m, that is, for a case where only the illumination light for the region R201-m illuminates.

In the ToF distance measuring device 11, M calibration parameters pₘ₋₁ (m=1 to M) obtained for the respective regions R201-m, that is, for the respective illumination light rays for the regions R201-m are written into the ROM 26.

The value of Confidence is calculated on the basis of the output data I_{(u,v)} and the output data Q_{(u,v)} for each pixel position (u, v) obtained by emitting only one laser 32-m (where m=1 to M). Then, the resulting Confidence value is recorded in the ROM 26 as received light intensity information C_{m-1(u,v)}.

By performing the calibration processing in this way, that is, by performing the write processing corresponding to FIG. 10, the calibration parameter pₘ₋₁ for a case where only the m-th (m=1 to M) region R201-m is illuminated with light is stored in the ROM 26.

The intensity of light received by the pixel at each pixel position (u, v) of the image sensor 23 in the case where only the m-th region R201-m is illuminated with light, that is, the received light intensity information C_{m-1(u,v)} indicating the value of Confidence is also stored in the ROM 26.

Next, processing performed for actual distance measurement will be described.

It is now assumed that the ToF distance measuring device 11 causes Mₐ lasers 32, which are two or more of the M lasers 32 constituting the laser group 32, to emit light. In other words, consider the case where Mₐ (two or more) regions R201 are targets for distance measurement.

In the following, an index indicating a laser 32 to emit light, that is, a region R201 to be illuminated with light, is referred to as r_m (where m=0 to Mₐ−1). The laser 32 indicated by the index r_m will be referred to as a laser 32-r_m, and the region R201 corresponding to the laser 32-r_m will be referred to as a region R201-r_m.

Accordingly, among the M lasers 32, the lasers 32 other than lasers 32-r_0 to 32-r_(Mₐ−1) do not emit light, and the laser 32-r_m illuminates the region R201-r_m with the illumination light for that region R201.

In this case, the computation unit 24 calculates outputs output data I_{r_m(u,v)}, output data Q_{r_m(u,v)}, and distance measurement result L_{(u,v)} that satisfy the following Equations (9) to (12).

Specifically, the computation unit 24 calculates a distance measurement result L_{(u,v)} based on the output data I_{(u,v)}, the output data Q_{(u,v)}, the pixel position (u, v), the calibration parameter p_{r_m}, the received light intensity information C_{r_m(u,v)}, and the light emission intensity adjustment value w_{r_m}, and outputs the resulting distance measurement result L_{(u,v)} to the outside via the output terminal 25. In the calculation of the distance measurement result L_{(u,v)} (calculation process), correction on the sine wave light, correction on the transmission time of the control signal are also made on the basis of the calibration parameter p_{r_m}.

$$[ Math . 9 ]$$

$${L}_{( u , v )} = F ( u , v , {I}_{r\_m ( u , v )} , {Q}_{r\_m ( u , v )} , {p}_{r\_m} ) \qquad ( 9 )$$

$$[ Math . 10 ]$$

$${Q}_{( u , v )} = {{\sum }^{Ma - 1}}_{m = 0} {Q}_{r\_m ( u , v )} \qquad ( 10 )$$

$$[ Math . 11 ]$$

$${I}_{( u , v )} = {{\sum }^{Ma - 1}}_{m = 0} {I}_{r\_m ( u , v )} \qquad ( 11 )$$

$$[ Math . 12 ]$$

$$\frac{{w}_{r\_m} \cdot {C}_{r\_m ( u , v )}}{{w}_{r\_ 0} \cdot {C}_{r\_ 0 ( u , v )}} = \frac{\sqrt{{( {I}_{r\_m ( u , v )} )}^{2} + {( {Q}_{r\_m ( u , v )} )}^{2}}}{\sqrt{{( {I}_{r\_ 0 ( u , v )} )}^{2} + {( {Q}_{r\_ 0 ( u , v )} )}^{2}}} , where m = 1 ∼ {M}_{a} - 1 \qquad ( 12 )$$

Here, m in the index r_m indicating the laser 32 to emit light is from 0 to Mₐ−1.

In Equation (12), w_{r_m} is a light emission intensity adjustment value indicating the amount of illumination light for the region R201-r_m for the laser 32-r_m indicated by the index r_m, and the value of the light emission intensity adjustment value w_{r_m} is any value from 0 to 100 as in the above-described example.

In actual distance measurement, the LDD 31-r_m causes the laser 32-r_m to emit light according to the light emission intensity adjustment value w_{r_m} determined by the control unit 21. In other words, the laser 32-r_m emits light with a light emission intensity (light amount) indicated by the light emission intensity adjustment value w_{r_m}.

Equations (9) to (12) will now be described.

In the case where the Mₐ lasers 32 (regions R201) emit light, the light (reflected light) received by each pixel of the image sensor 23 is a combined wave.

The pixel output based on the component of the light output from the laser 32-r_m in the combined wave, that is, the component of the illumination light for the region R201-r_m, is referred to as output data I_{r_m(u,v)} and output data Q_{r_m(u,v)}.

Since the calibration parameter for the case where only the illumination light for the region R201-r_m is used for distance measurement is p_{r_m}, Equation (9) holds (where m=0 to Mₐ−1).

In addition, equations (10) and (11) hold, where the output data I_{(u,v)} and the output data Q_{(u,v)}. are the output data I and Q actually output from the pixel at each pixel position (u, v), that is, the observed values of light at the pixel.

As described above, a value obtained by adding the square value of the output data I_{(u,v)} and the square value of the output data Q_{(u,v)} and then taking the square root of the resulting sum is the intensity of light received by the pixel at the pixel position (u,v). This is described, for example, in Equation (27) of NPL 1.

In actual distance measurement, the illumination light for the region R201-r_m is output with a light emission intensity indicated by the light emission intensity adjustment value w_{r_m}.

Therefore, the ratio of the intensity of the illumination light for the region R201-r_m, which is received by the pixel at each pixel position (u, v), is proportional to “w_{r_m}×C_{r_m(u,v)}”, so that Equation (12) holds.

Equations (9) to (12) are as described above.

The unknowns in Equations (9) to (12) are the distance measurement result L_{(u,v)}, output data I_{r_m(u,v)}, and output data Q_{r_m(u,v)}. Thus, by solving the simultaneous equations of Equations (9) to (12), these unknowns can be obtained and the resulting distance measurement result L_{(u,v)} can be output.

In a case where only one region R201-m is illuminated with light in distance measurement, the same processing as in step S104 and step S106 in FIG. 11 is performed. Specifically, a distance measurement result L_{(u,v)} is calculated on the basis of the calibration parameter pₘ₋₁ for the illumination light for the region R201-m.

Finally, the features and advantages of the present technology described above will be described.

First, the features and advantages of the first embodiment described above are as follows.

In the example indicated by the arrow Q53 in FIG. 5, for the region A, a combined wave of the light for illuminating the region R201-1 and the light for illuminating the region R201-2 is received for distance measurement to be performed.

Since these two light rays are different, the combined wave is different from the light for illuminating the region R201-1 and also from the light for illuminating the region R201-2. In addition, the ratio of “the light for illuminating the region R201-1” and “the light for illuminating the region R201-2” that make up the combined wave depends on the positions of pixels on the sensor where the combined wave is received.

Therefore, it is not known in what format the calibration parameters for the case where both the region R201-1 and the region R201-2 emit light should have, and how the calibration parameters are to be corrected.

Therefore, in the first embodiment, as the calibration parameters for the case where both the illumination light for the region R201-1 and the illumination light for the region R201-2 illuminate, appropriate values (calibration parameters p_{01(u,v)}) for the respective pixel positions are written into the ROM 26. This makes it possible to perform appropriate correction (calibration processing) for each pixel position.

The features and advantages of the second embodiment are as follows.

The intensity of light received by the pixel at each pixel position (u, v) of the image sensor 23 when only one of the regions R201 is illuminated with light, that is, data on the received light intensity information C_{m-1(u,v)} is written into the ROM 26. In actual distance measurement, calibration processing is performed using the ratio of this received light intensity information C_{m-1(u,v)}. With such a configuration, the amount of data required to be stored in the ROM 26 can be further reduced.

### <Configuration Example of Computer>

The above-described series of processing can also be performed by hardware or software. In the case where the series of processing is executed by software, a program that configures the software is installed on a computer. Here, the computer includes, for example, a computer built in dedicated hardware, a general-purpose personal computer on which various programs are installed to be able to execute various functions, and the like.

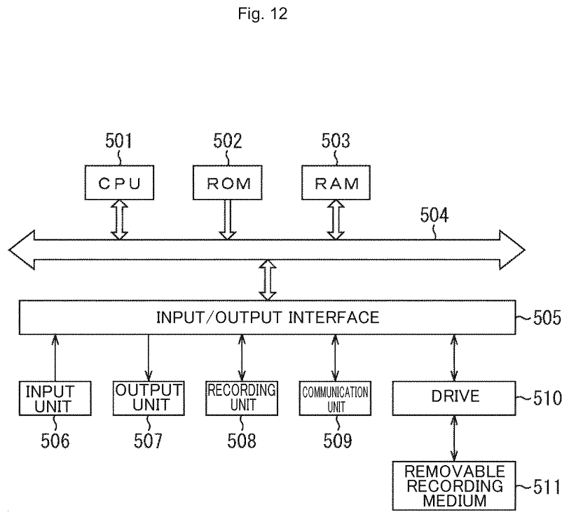

FIG. 12 is a block diagram illustrating a configuration example of computer hardware that executes the above-described series of processing using a program.

In the computer, a central processing unit (CPU) 501, a ROM 502, and a random access memory (RAM) 503 are connected to each other by a bus 504.

An input/output interface 505 is further connected to the bus 504. An input unit 506, an output unit 507, a recording unit 508, a communication unit 509, and a drive 510 are connected to the input/output interface 505.

The input unit 506 includes a keyboard, a mouse, a microphone, and an imaging element. The output unit 507 includes a laser, a display, a speaker, and the like. The recording unit 508 includes a hard disk and a nonvolatile memory. The communication unit 509 includes a network interface. The drive 510 drives a removable recording medium 511 such as a magnetic disk, an optical disc, a magneto-optical disk, or a semiconductor memory.

In the computer configured thus, the CPU 501 loads, for example, a program recorded in the recording unit 508 into the RAM 503 through the input/output interface 505 and the bus 504 and executes the program, so that the series of processing is performed.

The program to be executed by the computer (the CPU 501) can be provided in such a manner as to be recorded on, for example, the removable recording medium 511 serving as a packaged medium. The program can also be provided through a wired or wireless transmission medium such as a local area network, the Internet, or digital satellite broadcasting.

In the computer, the program can be installed on the recording unit 508 through the input/output interface 505 by loading the removable recording medium 511 into the drive 510. Furthermore, the program can be received by the communication unit 509 through a wired or wireless transfer medium and installed on the recording unit 508. In addition, the program can be installed in advance on the ROM 502 or the recording unit 508.

The program executed by a computer may be a program that performs processing chronologically in the order described in the present specification or may be a program that performs processing in parallel or at a necessary timing such as a called time.

### <Example of Application to Moving Body>

As described above, the technology of the present disclosure (the present technology) can be applied to various products. For example, the technology according to the present disclosure may be realized as a device equipped in any type of moving body such as an automobile, an electric vehicle, a hybrid electric vehicle, a motorcycle, a bicycle, a personal mobility device, an airplane, a drone, a ship, and a robot.

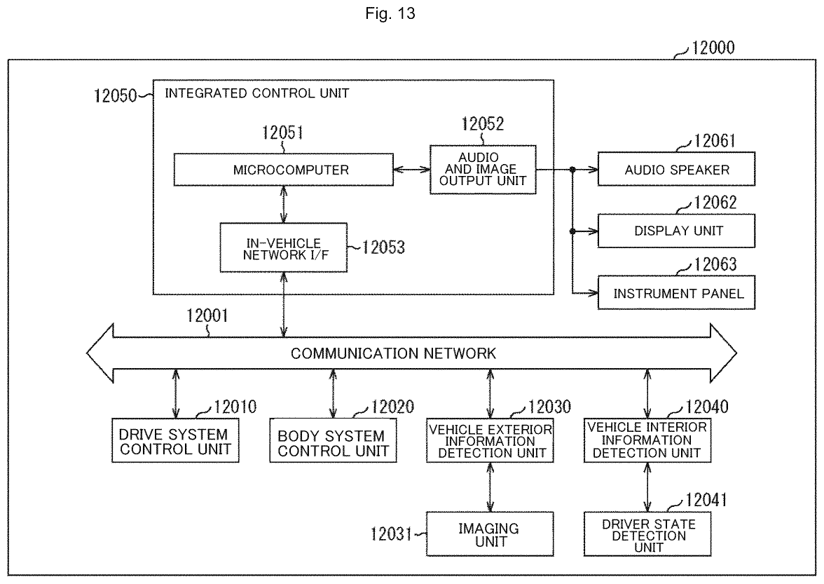

FIG. 13 is a block diagram illustrating a schematic configuration example of a vehicle control system, which is an example of a moving body control system to which the technology according to the present disclosure can be applied.

The vehicle control system 12000 includes a plurality of electronic control units connected thereto via a communication network 12001. In the example illustrated in FIG. 13, the vehicle control system 12000 includes a drive system control unit 12010, a body system control unit 12020, a vehicle exterior information detection unit 12030, a vehicle interior information detection unit 12040, and an integrated control unit 12050. In addition, as a functional configuration of the integrated control unit 12050, a microcomputer 12051, an audio and image output unit 12052, and an in-vehicle network interface (I/F) 12053 are illustrated.

The drive system control unit 12010 controls operations of devices related to a drive system of a vehicle according to various programs. For example, the drive system control unit 12010 functions as a control device for a driving force generation device for generating the driving force of the vehicle such as an internal combustion engine or a drive motor, a driving force transmission mechanism for transmitting the driving force to the wheels, a steering mechanism for adjusting the steering angle of the vehicle, a braking device for generating the braking force of the vehicle, or the like.

The body system control unit 12020 controls operations of various devices mounted in the vehicle body according to various programs. For example, the body system control unit 12020 functions as a control device of a keyless entry system, a smart key system, a power window device, or various lamps such as a headlamp, a back lamp, a brake lamp, a turn signal, and a fog lamp. In this case, radio waves transmitted from a portable device that substitutes for a key or signals of various switches may be input to the body system control unit 12020. The body system control unit 12020 receives inputs of the radio waves or signals and controls a door lock device, a power window device, and a lamp of the vehicle.

The vehicle exterior information detection unit 12030 detects information on the outside of the vehicle equipped with the vehicle control system 12000. For example, an imaging unit 12031 is connected to the vehicle exterior information detection unit 12030. The vehicle exterior information detection unit 12030 causes the imaging unit 12031 to capture an image of the outside of the vehicle and receives the captured image. The vehicle exterior information detection unit 12030 may perform object detection processing or distance detection processing for peoples, cars, obstacles, signs, and letters on the road on the basis of the received image.

The imaging unit 12031 is an optical sensor that receives light and outputs an electrical signal according to the amount of the received light. The imaging unit 12031 can also output the electrical signal as an image or distance measurement information. In addition, the light received by the imaging unit 12031 may be visible light or invisible light such as infrared light.

The vehicle interior information detection unit 12040 detects information on the inside of the vehicle. For example, a driver state detection unit 12041 that detects a driver's state is connected to the vehicle interior information detection unit 12040. The driver state detection unit 12041 includes, for example, a camera that captures an image of a driver, and the vehicle interior information detection unit 12040 may calculate a degree of fatigue or concentration of the driver or may determine whether or not the driver is dozing on the basis of detection information input from the driver state detection unit 12041.

The microcomputer 12051 can calculate a control target value of the driving force generation device, the steering mechanism, or the braking device on the basis of the information on the outside or the inside of the vehicle acquired by the vehicle exterior information detection unit 12030 or the vehicle interior information detection unit 12040 and output a control command to the drive system control unit 12010. For example, the microcomputer 12051 can perform cooperative control for the purpose of realizing functions of an advanced driver assistance system (ADAS) including collision avoidance or impact mitigation of a vehicle, following traveling based on inter-vehicle distance, vehicle speed maintenance driving, vehicle collision warning, vehicle lane deviation warning, or the like.

Further, by controlling the driving force generation device, the steering mechanism, the braking device, and the like on the basis of information regarding the vicinity of the vehicle acquired by the vehicle exterior information detection unit 12030 or the vehicle interior information detection unit 12040, the microcomputer 12051 can perform cooperative control for the purpose of automated driving or the like in which autonomous travel is performed without depending on an operation of the driver.

The microcomputer 12051 can also output a control command to the body system control unit 12020 based on the information outside of the vehicle acquired by the vehicle exterior information detection unit 12030. For example, the microcomputer 12051 can perform cooperative control for the purpose of preventing glare such as controlling the headlamps to switch a high beam to a low beam according to the position of a preceding vehicle or an oncoming vehicle detected by the vehicle exterior information detection unit 12030.

The audio and image output unit 12052 transmits an output signal of at least one of an audio and an image to an output device capable of notifying an occupant of the vehicle or the outside of the vehicle of information visually or audibly. In the example of FIG. 13, an audio speaker 12061, a display unit 12062, and an instrument panel 12063 are illustrated as examples of the output device. The display unit 12062 may include at least one of an on-board display and a head-up display, for example.

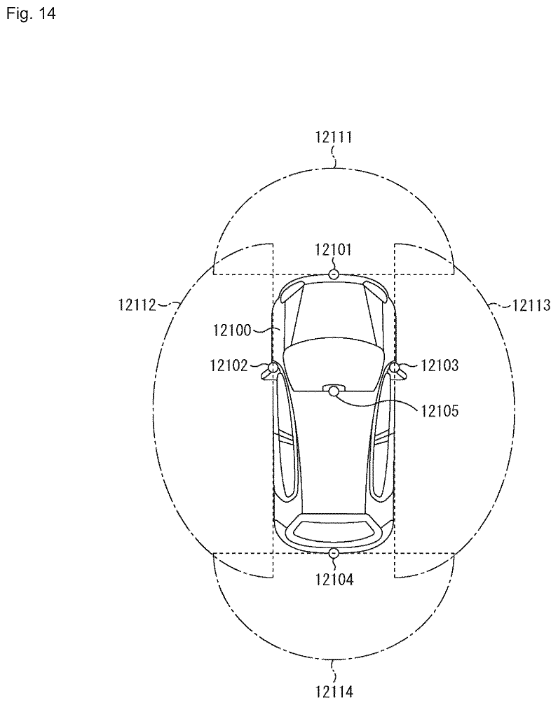

FIG. 14 is a diagram illustrating an example of the installation positions of imaging units 12031.

In FIG. 14, a vehicle 12100 includes imaging units 12101, 12102, 12103, 12104, and 12105 as the imaging units 12031.

The imaging units 12101, 12102, 12103, 12104, and 12105 are provided, for example, at positions such as a front nose, side mirrors, a rear bumper, a back door, and an upper part of a windshield in the occupant compartment of the vehicle 12100. The imaging unit 12101 provided on the front nose and the imaging unit 12105 provided on the upper part of the windshield in the occupant compartment mainly acquire images in front of the vehicle 12100. The imaging units 12102 and 12103 provided on the side mirrors mainly acquire images on the sides of the vehicle 12100. The imaging unit 12104 provided on the rear bumper or the back door mainly acquires images of a side behind the vehicle 12100. The front view images acquired by the imaging units 12101 and 12105 are mainly used for detection of preceding vehicles, pedestrians, obstacles, traffic signals, traffic signs, lanes, and the like.

FIG. 14 illustrates an example of imaging ranges of the imaging units 12101 to 12104. An imaging range 12111 indicates an imaging range of the imaging unit 12101 provided at the front nose, imaging ranges 12112 and 12113 respectively indicate the imaging ranges of the imaging units 12102 and 12103 provided at the side-view mirrors, and an imaging range 12114 indicates the imaging range of the imaging unit 12104 provided at the rear bumper or the back door. For example, a bird's-eye view image of the vehicle 12100 as viewed from above can be obtained by superimposing pieces of image data captured by the imaging units 12101 to 12104.

At least one of the imaging units 12101 to 12104 may have a function for obtaining distance information. For example, at least one of the imaging units 12101 to 12104 may be a stereo camera constituted by a plurality of imaging elements or may be an imaging element that has pixels for phase difference detection.

For example, the microcomputer 12051 can extract, particularly, a closest three-dimensional object on a path along which the vehicle 12100 is traveling, which is a three-dimensional object traveling at a predetermined speed (for example, 0 km/h or higher) in the substantially same direction as the vehicle 12100, as a preceding vehicle by acquiring a distance to each of three-dimensional objects in the imaging ranges 12111 to 12114 and temporal change in the distance (a relative speed with respect to the vehicle 12100) on the basis of the distance information obtained from the imaging units 12101 to 12104. Further, the microcomputer 12051 can set an inter-vehicle distance which should be secured in front of the vehicle in advance with respect to the preceding vehicle and can perform automated brake control (also including following stop control) or automated acceleration control (also including following start control). In this way, it is possible to perform cooperative control for the purpose of automated driving or the like in which a vehicle autonomously travels without depending on operations of the driver.

For example, the microcomputer 12051 can classify and extract three-dimensional data regarding three-dimensional objects into two-wheeled vehicles, normal vehicles, large vehicles, pedestrians, and other three-dimensional objects such as electric poles based on distance information obtained from the imaging units 12101 to 12104 and can use the three-dimensional data to perform automated avoidance of obstacles. For example, the microcomputer 12051 differentiates surrounding obstacles of the vehicle 12100 into obstacles which can be viewed by the driver of the vehicle 12100 and obstacles which are difficult to view. Then, the microcomputer 12051 determines a collision risk indicating the degree of risk of collision with each obstacle, and when the collision risk is equal to or higher than a set value and there is a possibility of collision, an alarm is output to the driver through the audio speaker 12061 or the display unit 12062, forced deceleration or avoidance steering is performed through the drive system control unit 12010, and thus it is possible to perform driving support for collision avoidance.

At least one of the imaging units 12101 to 12104 may be an infrared camera that detects infrared rays. For example, the microcomputer 12051 can recognize a pedestrian by determining whether there is a pedestrian in the captured image of the imaging units 12101 to 12104. Such pedestrian recognition is performed by, for example, a procedure in which feature points in the captured images of the imaging units 12101 to 12104 as infrared cameras are extracted and a procedure in which pattern matching processing is performed on a series of feature points indicating an outline of an object to determine whether or not the object is a pedestrian. When the microcomputer 12051 determines that there is a pedestrian in the captured images of the imaging units 12101 to 12104 and the pedestrian is recognized, the audio and image output unit 12052 controls the display unit 12062 so that a square contour line for emphasis is superimposed and displayed with the recognized pedestrian. In addition, the audio and image output unit 12052 may control the display unit 12062 so that an icon indicating a pedestrian or the like is displayed at a desired position.

An example of the vehicle control system to which the technology according to the present disclosure can be applied has been described above. The technology according to the present disclosure can be applied to the imaging unit 12031 and the vehicle exterior information detection unit 12030 among the above-described components. Specifically, for example, the ToF distance measuring device 11 illustrated in FIG. 6 can be used as the imaging unit 12031 and the vehicle exterior information detection unit 12030.

Embodiments of the present technology are not limited to the embodiments described above, and various modifications can be made without departing from the scope and spirit of the present technology.

For example, the present technology may have a configuration of clouding computing in which a plurality of devices share and process one function together via a network.

In addition, each step described in the above flowchart can be executed by one device or executed in a shared manner by a plurality of devices.

Furthermore, in a case where a plurality of kinds of processing are included in a single step, the plurality of kinds of processing included in the single step may be executed by one device or by a plurality of devices in a shared manner.

Furthermore, the present technology can be configured as follows.
(1)

A distance measuring device configured to illuminate with light selectively one or more regions as targets for distance measurement among a plurality of regions, the distance measuring device including a computation unit that in a case where two or more of the plurality of regions are illuminated with illumination light for the respective regions,
calculates a distance to the region based on output data output from each pixel of a sensor that receives light from the plurality of regions, the output data corresponding to an amount of light received at the pixel,
based on information regarding a contribution rate of the illumination light for the region in light received at the pixel, and based on a calibration parameter for a case where only the illumination light for one of the regions illuminates, the calibration parameter being calculated for the illumination light for each region as a target for distance measurement.
(2)

The distance measuring device according to (1), wherein in calculating the distance, correction is performed based on the calibration parameter.
(3)

The distance measuring device according to (1) or (2), wherein the calibration parameter is commonly used for all pixels of the sensor.
(4)

The distance measuring device according to any one of (1) to (3), wherein in a case where the illumination light for each region illuminates with a light amount corresponding to a light emission intensity adjustment value,
the computation unit calculates the distance based on the output data, the information regarding the contribution rate, the calibration parameter, and the light emission intensity adjustment value for the illumination light for each region.
(5)

The distance measuring device according to any one of (1) to (4), wherein in a case where only one of the regions is illuminated with the illumination light for the region, the computation unit calculates the distance based on the output data and the calibration parameter.
(6)

The distance measuring device according to any one of (1) to (5), wherein the computation unit calculates the distance for each pixel.
(7)

The distance measuring device according to any one of (1) to (6), further including a recording unit that records the information regarding the contribution rate and the calibration parameter.
(8)

A distance measuring method including, by a distance measuring device configured to illuminate with light selectively one or more regions as targets for distance measurement among a plurality of regions,
in a case where two or more of the plurality of regions are illuminated with illumination light for the respective regions,
calculating a distance to the region based on output data output from each pixel of a sensor that receives light from the plurality of regions, the output data corresponding to an amount of light received at the pixel,
based on information regarding a contribution rate of the illumination light for the region in light received at the pixel, and based on a calibration parameter for a case where only the illumination light for one of the regions illuminates, the calibration parameter being calculated for the illumination light for each region as a target for distance measurement.
(9)

A program causing a computer for controlling a distance measuring device configured to illuminate with light selectively one or more regions as targets for distance measurement among a plurality of regions to execute processing including a step of,
in a case where two or more of the plurality of regions are illuminated with illumination light for the respective regions,
calculating a distance to the region based on output data output from each pixel of a sensor that receives light from the plurality of regions, the output data corresponding to an amount of light received at the pixel,
based on information regarding a contribution rate of the illumination light for the region in light received at the pixel, and based on a calibration parameter for a case where only the illumination light for one of the regions illuminates, the calibration parameter being calculated for the illumination light for each region as a target for distance measurement.
(10)

A distance measuring device configured to illuminate with light selectively one or more regions as targets for distance measurement among a plurality of regions, the distance measuring device including a recording unit that records information regarding a contribution rate, calculated for each pixel of a sensor that receives light from the plurality of regions, of the illumination light for the region in light received at the pixel, and
a calibration parameter for a case where only the illumination light for one of the regions illuminates, the calibration parameter being calculated for the illumination light for each region.
(11)

A distance measuring device configured to illuminate with light selectively one or more regions as targets for distance measurement among a plurality of regions, the distance measuring device including a computation unit that in a case where two or more of the plurality of regions are illuminated with illumination light for the respective regions,
calculates a distance to the region based on output data output from each pixel of a sensor that receives light from the plurality of regions, the output data corresponding to an amount of light received at the pixel, and based on a calibration parameter calculated for the each pixel.
(12)

The distance measuring device according to (11), wherein in calculating the distance, correction is performed based on the calibration parameter.
(13)

The distance measuring device according to (11) or (12), wherein in a case where only one of the regions is illuminated with the illumination light for the region, the computation unit calculates the distance based on the output data and a calibration parameter common for all pixels of the sensor for a case where only the illumination light for the one region illuminates.
(14)

The distance measuring device according to any one of (11) to (13), wherein the computation unit calculates the distance for each pixel.
(15)

The distance measuring device according to (13), further including a recording unit that records the calibration parameter calculated for each pixel and the calibration parameter common for all pixels calculated for the illumination light for each region.
(16)

A distance measuring method including, by a distance measuring device configured to illuminate with light selectively one or more regions as targets for distance measurement among a plurality of regions,
in a case where two or more of the plurality of regions are illuminated with illumination light for the respective regions,
calculating a distance to the region based on output data output from each pixel of a sensor that receives light from the plurality of regions, the output data corresponding to an amount of light received at the pixel, and based on a calibration parameter calculated for the each pixel.
(17)

A program causing a computer for controlling a distance measuring device configured to illuminate with light selectively one or more regions as targets for distance measurement among a plurality of regions to execute processing including a step of,
in a case where two or more of the plurality of regions are illuminated with illumination light for the respective regions,
calculating a distance to the region based on output data output from each pixel of a sensor that receives light from the plurality of regions, the output data corresponding to an amount of light received at the pixel, and based on a calibration parameter calculated for the each pixel.
(18)

A distance measuring device configured to illuminate with light selectively one or more regions as targets for distance measurement among a plurality of regions, the distance measuring device including a recording unit that records a calibration parameter calculated for each pixel of a sensor that receives light from the plurality of regions.

### REFERENCE SIGNS LIST

11 ToF distance measuring device
21 Control unit
22 Light emitting unit
23 Image sensor
24 Computation unit
25 Output terminal
26 ROM

1. A distance measuring device configured to illuminate with light selectively one or more regions as targets for distance measurement among a plurality of regions, the distance measuring device comprising a computation unit that in a case where two or more of the plurality of regions are illuminated with illumination light for the respective regions,
calculates a distance to the region based on output data output from each pixel of a sensor that receives light from the plurality of regions, the output data corresponding to an amount of light received at the pixel,
based on information regarding a contribution rate of the illumination light for the region in light received at the pixel, and based on a calibration parameter for a case where only the illumination light for one of the regions illuminates, the calibration parameter being calculated for the illumination light for each region as a target for distance measurement.

2. The distance measuring device according to claim 1, wherein in calculating the distance, correction is performed based on the calibration parameter.

3. The distance measuring device according to claim 1, wherein the calibration parameter is commonly used for all pixels of the sensor.

4. The distance measuring device according to claim 1, wherein in a case where the illumination light for each region illuminates with a light amount corresponding to a light emission intensity adjustment value,
the computation unit calculates the distance based on the output data, the information regarding the contribution rate, the calibration parameter, and the light emission intensity adjustment value for the illumination light for each region.

5. The distance measuring device according to claim 1, wherein in a case where only one of the regions is illuminated with the illumination light for the region,
the computation unit calculates the distance based on the output data and the calibration parameter.

6. The distance measuring device according to claim 1, wherein the computation unit calculates the distance for each pixel.

7. The distance measuring device according to claim 1, further comprising a recording unit that records the information regarding the contribution rate and the calibration parameter.

8. A distance measuring method comprising, by a distance measuring device configured to illuminate with light selectively one or more regions as targets for distance measurement among a plurality of regions,
in a case where two or more of the plurality of regions are illuminated with illumination light for the respective regions,
calculating a distance to the region based on output data output from each pixel of a sensor that receives light from the plurality of regions, the output data corresponding to an amount of light received at the pixel,
based on information regarding a contribution rate of the illumination light for the region in light received at the pixel, and based on a calibration parameter for a case where only the illumination light for one of the regions illuminates, the calibration parameter being calculated for the illumination light for each region as a target for distance measurement.

9. A program causing a computer for controlling a distance measuring device configured to illuminate with light selectively one or more regions as targets for distance measurement among a plurality of regions to execute processing comprising a step of,
in a case where two or more of the plurality of regions are illuminated with illumination light for the respective regions,
calculating a distance to the region based on output data output from each pixel of a sensor that receives light from the plurality of regions, the output data corresponding to an amount of light received at the pixel,
based on information regarding a contribution rate of the illumination light for the region in light received at the pixel, and based on a calibration parameter for a case where only the illumination light for one of the regions illuminates, the calibration parameter being calculated for the illumination light for each region as a target for distance measurement.

10. A distance measuring device configured to illuminate with light selectively one or more regions as targets for distance measurement among a plurality of regions, the distance measuring device comprising a recording unit that records information regarding a contribution rate, calculated for each pixel of a sensor that receives light from the plurality of regions, of the illumination light for the region in light received at the pixel, and
a calibration parameter for a case where only the illumination light for one of the regions illuminates, the calibration parameter being calculated for the illumination light for each region.

11. A distance measuring device configured to illuminate with light selectively one or more regions as targets for distance measurement among a plurality of regions, the distance measuring device comprising a computation unit that in a case where two or more of the plurality of regions are illuminated with illumination light for the respective regions,
calculates a distance to the region based on output data output from each pixel of a sensor that receives light from the plurality of regions, the output data corresponding to an amount of light received at the pixel, and
based on a calibration parameter calculated for the each pixel.

12. The distance measuring device according to claim 11, wherein in calculating the distance, correction is performed based on the calibration parameter.

13. The distance measuring device according to claim 11, wherein in a case where only one of the regions is illuminated with the illumination light for the region,
the computation unit calculates the distance based on the output data and a calibration parameter common for all pixels of the sensor for a case where only the illumination light for the one region illuminates.

14. The distance measuring device according to claim 11, wherein the computation unit calculates the distance for each pixel.

15. The distance measuring device according to claim 13, further comprising a recording unit that records the calibration parameter calculated for each pixel and the calibration parameter common for all pixels calculated for the illumination light for each region.

16. A distance measuring method comprising, by a distance measuring device configured to illuminate with light selectively one or more regions as targets for distance measurement among a plurality of regions,
in a case where two or more of the plurality of regions are illuminated with illumination light for the respective regions,
calculating a distance to the region based on output data output from each pixel of a sensor that receives light from the plurality of regions, the output data corresponding to an amount of light received at the pixel, and
based on a calibration parameter calculated for the each pixel.

17. A program causing a computer for controlling a distance measuring device configured to illuminate with light selectively one or more regions as targets for distance measurement among a plurality of regions to execute processing comprising a step of,
in a case where two or more of the plurality of regions are illuminated with illumination light for the respective regions,
calculating a distance to the region based on output data output from each pixel of a sensor that receives light from the plurality of regions, the output data corresponding to an amount of light received at the pixel, and
based on a calibration parameter calculated for the each pixel.

18. A distance measuring device configured to illuminate with light selectively one or more regions as targets for distance measurement among a plurality of regions, the distance measuring device comprising a recording unit that records a calibration parameter calculated for each pixel of a sensor that receives light from the plurality of regions.
